(19) United States
(12) Patent Application Publication
(10) Pub. No.: US 2024/0318660 A1
(43) Pub. Date: Sep. 26, 2024

(54) TURBOMACHINE AND METHOD OF ASSEMBLY

(71) Applicant: General Electric Company, Schenectady, NY (US)

(72) Inventors: Jixian Yao, Niskayuna, NY (US); Trevor Howard Wood, Clifton Park, NY (US); Kishore Ramakrishnan, Rexford, NY (US); William Joseph Solomon, Montgomery, OH (US); Giridhar Jothiprasad, Clifton Park, NY (US); Aaron J. King, West Harrison, OH (US)

(21) Appl. No.: 18/678,303

(22) Filed: May 30, 2024

Related U.S. Application Data
(63) Continuation-in-part of application No. 18/654,444, filed on May 3, 2024.
Application No. 18/654,444 is a continuation-in-part of application No. 18/511,128, filed on Nov. 16, 2023.
Application No. 18/511,128 is a continuation of application No. 18/138,442, filed on Apr. 24, 2023, now Pat. No. 11,852,161.
Application No. 18/138,442 is a continuation-in-part of application No. 17/986,544, filed on Nov. 14, 2022, now Pat. No. 11,661,851.

(51) Int. Cl. F04D 29/38; F04D 19/00

(52) U.S. Cl. CPC F04D 29/384; F04D 19/002

(57) ABSTRACT

A turbomachine includes an annular casing, a fan disposed inside the annular casing and mounted for rotation about an axial centerline, and an airfoil. The fan includes fan blades that extend radially outwardly toward the annular casing. The airfoil includes a first side and a second side coupled together at a leading edge and a trailing edge, a plurality of first chord sections defining at least one first chord length, and a plurality of second chord sections defining at least one second chord length. The plurality of first chord sections and second chord sections define a waveform along a leading edge of the airfoil. The fan has an average chord fan width according to a first performance factor. The fan has a quantity of fan blades according to a second performance factor.

### CROSS REFERENCE TO RELATED APPLICATIONS

This application is a continuation-in-part of application U.S. Ser. No. 18/654,444, filed May 3, 2024, which is a continuation-in-part of application U.S. Ser. No. 18/511,128, filed Nov. 16, 2023, which is a continuation of application U.S. Ser. No. 18/138,442, filed on Apr. 24, 2023, now U.S. Pat. No. 11,852,161, which is a continuation-in-part of application U.S. 17/986,544, filed on Nov. 14, 2022, now U.S. Pat. No. 11,661,851, the contents of all of which are incorporated herein by reference in their entireties.

### FIELD

The present disclosure relates generally to jet engines and, more particularly, to jet engine fans.

### BACKGROUND

In one form, a gas turbine engine can include a fan and a core arranged in flow communication with one another. The core generally includes, in serial flow order, a compressor section, a combustion section, a turbine section, and an exhaust section. The fan and the core may be partially surrounded by an outer nacelle. In such approaches, the outer nacelle defines a bypass airflow passage with the core.

In operation, air is provided from the fan to an inlet of the compressor section where one or more axial compressors progressively compress the air until it reaches the combustion section. Fuel is mixed with the compressed air using one or more fuel nozzles within the combustion section and burned to provide combustion gases. The combustion gases are routed from the combustion section to the turbine section. The flow of combustion gases through the turbine section drives the turbine section and is then routed through the exhaust section to atmosphere.

### BRIEF DESCRIPTION OF THE DRAWINGS

A full and enabling disclosure of the present disclosure, including the best mode thereof, directed to one of ordinary skill in the art, is set forth in the specification, with reference to the appended figures, in which:

FIG. 1 is a schematic, cross-sectional view of a gas turbine engine in accordance with exemplary aspects of the present disclosure;

FIG. 2 is a sectional view of a fan blade in accordance with exemplary aspects of the present disclosure;

FIG. 3 shows first example engines arranged on a first plot in accordance with a first performance factor for a fan module according to the present disclosure;

FIG. 4 shows second example engines arranged on a second plot in accordance with a second performance factor for a fan module according to the present disclosure;

FIG. 5 shows third example engines arranged on a third plot in accordance with the first performance factor for a fan module according to the present disclosure;

FIG. 6 shows fourth example engines arranged on a fourth plot in accordance with the second performance factor for a fan module according to the present disclosure;

FIG. 7 is a schematic illustration of an exemplary turbine engine;

FIG. 8 is an enlarged view of a portion of the engine shown in FIG. 7;

FIG. 9 is a perspective view of an airfoil that may be used with the engine shown in FIG. 7;

FIG. 10 is an enlarged view of a portion of the airfoil shown in FIG. 9;

FIG. 11 is a cross-sectional end view of a portion of the airfoil shown in FIG. 9;

FIG. 12 is a cross-sectional view of a first chord section of the airfoil shown in FIG. 9;

FIG. 13 is a cross-sectional view of a second chord section of the airfoil shown in FIG. 9;

FIG. 14 is a cross-sectional view of the first and second chord sections of the airfoil shown in FIG. 9;

FIG. 15 is a schematic plan view of an airfoil according to an embodiment;

FIG. 16 is a schematic plan view of an airfoil according to an embodiment;

FIG. 17 is a perspective view of another embodiment of an airfoil that may be used with the engine shown in FIG. 7;

FIG. 18 is a schematic plan view of an airfoil according to an embodiment;

FIG. 19 is a schematic plan view of an airfoil according to an embodiment;

FIG. 20 is a schematic plan view of an airfoil according to an embodiment; and

FIG. 21 is a schematic plan view of an airfoil according to an embodiment.

Elements in the figures are illustrated for simplicity and clarity and have not necessarily been drawn to scale. For example, the dimensions and/or relative positioning of some of the elements in the figures may be exaggerated relative to other elements to help to improve understanding of variations of the present disclosure. Also, common but well-understood elements that are useful or necessary in a commercially feasible embodiment are often not depicted in order to facilitate a less obstructed view of these variations of the present disclosure. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first” and “second” may be used interchangeably to distinguish one component from another and are not intended to signify location or importance of the individual components.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows.

The terms “radial” or “radially” refer to a direction away from a common center. For example, in the overall context of a turbine engine, radial refers to a direction along a ray extending between a center longitudinal axis of the engine and an outer engine circumference.

The term “composite,” as used herein is, refers to a material that includes non-metallic elements or materials. As used herein, a “composite component” or “composite material” refers to a structure or a component including any suitable composite material. A composite material can be a combination of at least two or more non-metallic elements or materials. Examples of a composite material can be, but not limited to, a polymer matrix composite (PMC), a ceramic matrix composite (CMC), a metal matrix composite (MMC), carbon fibers, a polymeric resin, a thermoplastic resin, bismaleimide (BMI) materials, polyimide materials, an epoxy resin, glass fibers, and silicon matrix materials. Composite components, such as a composite airfoil, can include several layers or plies of composite material. The layers or plies can vary in stiffness, material, and dimension to achieve the desired composite component or composite portion of a component having a predetermined weight, size, stiffness, and strength. One or more layers of adhesive can be used in forming or coupling composite components. Adhesives can include resin and phenolics, wherein the adhesive can require curing at elevated temperatures or other hardening techniques.

As used herein, “PMC” refers to a class of materials. By way of example, the PMC material is defined in part by a prepreg, which is a reinforcement material pre-impregnated with a polymer matrix material, such as thermoplastic resin. Non-limiting examples of processes for producing thermoplastic prepregs include hot melt pre-pregging in which the fiber reinforcement material is drawn through a molten bath of resin and powder pre-pregging in which a resin is deposited onto the fiber reinforcement material, by way of non-limiting example electrostatically, and then adhered to the fiber, by way of non-limiting example, in an oven or with the assistance of heated rollers. The prepregs can be in the form of unidirectional tapes or woven fabrics, which are then stacked on top of one another to create the number of stacked plies desired for the part. Multiple layers of prepreg may be stacked to the proper thickness and orientation for the composite component and then the resin is cured and solidified to render a fiber reinforced composite part. Resins for matrix materials of PMCs can be generally classified as thermosets or thermoplastics. Thermoplastic resins are generally categorized as polymers that can be repeatedly softened and flowed when heated and hardened when sufficiently cooled due to physical rather than chemical changes. Notable example classes of thermoplastic resins include nylons, thermoplastic polyesters, polyaryletherketones, and polycarbonate resins. Specific example of high performance thermoplastic resins that have been contemplated for use in aerospace applications include, polyetheretherketone (PEEK), polyetherketoneketone (PEKK), polyetherimide (PEI), polyaryletherketone (PAEK), and polyphenylene sulfide (PPS). In contrast, once fully cured into a hard rigid solid, thermoset resins do not undergo significant softening when heated, but instead thermally decompose when sufficiently heated. Notable examples of thermoset resins include epoxy, bismaleimide (BMI), and polyimide resins.

Instead of using a prepreg, in another non-limiting example, with the use of thermoplastic polymers, it is possible to utilize a woven fabric. Woven fabric can include, but is not limited to, dry carbon fibers woven together with thermoplastic polymer fibers or filaments. Non-prepreg braided architectures can be made in a similar fashion. With this approach, it is possible to tailor the fiber volume of the part by dictating the relative concentrations of the thermoplastic fibers and reinforcement fibers that have been woven or braided together. Additionally, different types of reinforcement fibers can be braided or woven together in various concentrations to tailor the properties of the part. For example, glass fibers, carbon fibers, and thermoplastic fibers could all be woven together in various concentrations to tailor the properties of the part. The carbon fibers provide the strength of the system, the glass fibers can be incorporated to enhance the impact properties, which is a design characteristic for parts located near the inlet of the engine, and the thermoplastic fibers provide the binding for the reinforcement fibers.

In yet another non-limiting example, resin transfer molding (RTM) can be used to form at least a portion of a composite component. Generally, RTM includes the application of dry fibers or matrix material to a mold or cavity. The dry fibers or matrix material can include prepreg, braided material, woven material, or any combination thereof.

Resin can be pumped into or otherwise provided to the mold or cavity to impregnate the dry fibers or matrix material. The combination of the impregnated fibers or matrix material and the resin are then cured and removed from the mold. When removed from the mold, the composite component can require post-curing processing.

It is contemplated that RTM can be a vacuum assisted process. That is, the air from the cavity or mold can be removed and replaced by the resin prior to heating or curing. It is further contemplated that the placement of the dry fibers or matrix material can be manual or automated.

The dry fibers or matrix material can be contoured to shape the composite component or direct the resin. Optionally, additional layers or reinforcing layers of material differing from the dry fiber or matrix material can also be included or added prior to heating or curing.

The singular forms “a,” “an,” and “the” include plural references unless the context clearly dictates otherwise.

The inventors have sought to maximize efficiency of turbine engines during in-flight propulsion of an aircraft, and correspondingly reduce fuel consumption. In particular, the inventors were focused on how the fan of a ducted turbine engine can be improved. The inventors, in consideration of several different engine architectures proposed, considered how the fan module would need to change to achieve mission requirements, and/or how the fan module could improve upon an existing engine efficiency and/or fuel consumption. The inventors looked at several engine architectures, then determined how the number of fan blades utilized with a fan, average chord width of the fan blades, diameter of the fan blade, fan pressure ratio, fan tip speed, and hub-to-tip ratio affect engine efficiency and/or fuel consumption.

The inventors found that in some engines, an excess number of fan blades may add unnecessary cost to the engine design without appreciable benefit, and may also add unnecessary weight to an aircraft, thereby reducing overall fuel efficiency (e.g., due to increased fuel burn). A reduction in fan blade quantity, however, was found to potentially lead to a reduction in total fan blade area desired for efficient propulsion, fan aeromechanical stability and operability, etc. The inventors considered increasing the width or fan chord of the fan blades to achieve a desired fan blade area with a lower fan blade count. Such considerations were found to be of particular interest when the engine had a higher bypass ratio (i.e., lower fan pressure ratio), and when the engine had a lower blade tip speed.

The determination of the fan blade count and average fan chord for achieving a desired efficiency often required a time consuming, iterative process. As explained in greater detail below, after evaluation of numerous turbine engine architectures having different fan blade counts and average fan chords, it was found, unexpectedly, that there exist certain relationships between a fan or fan blade diameter, a fan pressure ratio, and a redline corrected fan tip Mach number of the turbine engine that identify an average fan chord needed to produce improved results in terms of engine efficiency. It was further found, unexpectedly, that there exist certain relationships between turbine engine parameters including a hub-to-tip ratio of the fan, a fan pressure ratio, and a redline corrected fan tip Mach number of the turbine engine that identify a fan blade count needed to produce improved results in terms of engine efficiency.

Various aspects of the present disclosure describe aspects of an aircraft turbine engine characterized in part by an increased average fan chord width and a reduced blade count, which are believed to result in an improved engine aerodynamic efficiency and/or improved fuel efficiency. According to the disclosure, a turbomachine for powering an aircraft in flight comprises an annular casing and a fan disposed inside the annular casing and mounted for rotation about an axial centerline, the fan including fan blades that extend radially outwardly toward the annular casing.

Reference will now be made in detail to embodiments of the disclosure, one or more examples of which are illustrated in the accompanying drawings, which are incorporated in and constitute a part of this specification, illustrate embodiments of the disclosure and, together with the description, serve to explain the principles of the disclosure. The detailed description uses numerical and letter designations to refer to features in the drawings. Like or similar designations in the drawings and description have been used to refer to like or similar parts of the disclosure.

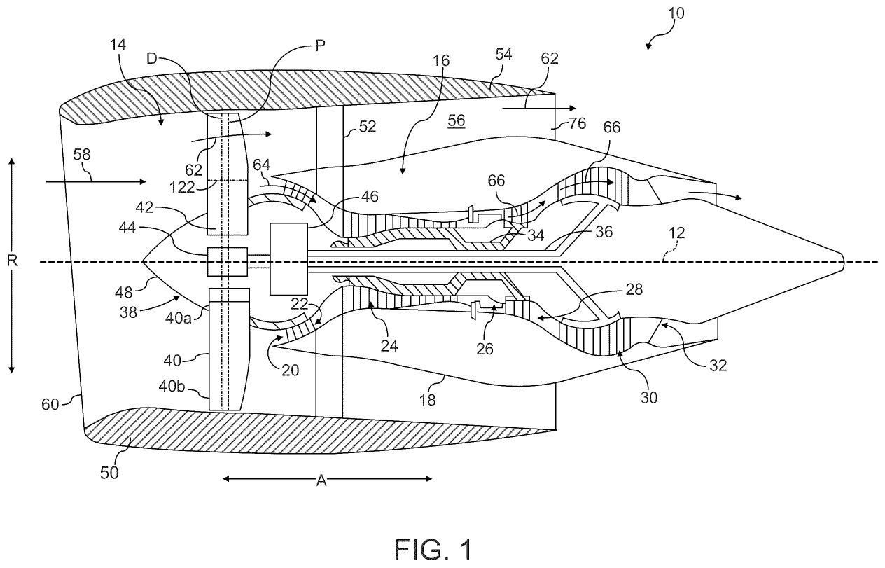

Referring now to the drawings, FIG. 1 is a schematic, cross-sectional view of a turbomachine, more specifically a gas turbine engine 10, in accordance with an exemplary embodiment of the present disclosure. More particularly, for the embodiment of FIG. 1, the gas turbine engine 10 is a high-bypass turbofan jet engine. gas turbine engine 10 As shown in FIG. 1, the gas turbine engine 10 defines an axial direction A (extending parallel to a longitudinal centerline 12 provided for reference) and a radial direction R. In general, the gas turbine engine 10 includes a fan section 14 and a core turbine engine 16 disposed downstream from the fan section 14.

The exemplary core turbine engine 16 depicted generally includes a substantially tubular outer casing 18 that defines an annular inlet 20. The tubular outer casing 18 encases, in serial flow relationship, a compressor section including a booster, such as a low pressure (LP) compressor 22, and a high pressure (HP) compressor 24; a combustion section 26; a turbine section including a high pressure (HP) turbine 28 and a low pressure (LP) turbine 30; and an exhaust nozzle 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

Fan blades 40 extend outwardly from disk 42 generally along the radial direction R. For the embodiment depicted, the fan section 14 includes a variable pitch fan 38 having a plurality of fan blades 40 coupled to a disk 42 in a spaced apart manner. One or more of the fan blades 40 may rotatable relative to the disk 42 about a pitch axis P by virtue of the fan blades 40 being operatively coupled to a suitable actuator 44 configured to vary the pitch of the fan blades 40, typically collectively in unison. In some approaches, the fan is a fixed pitch fan and actuator 44 is not present. The fan blades 40, disk 42, and actuator 44 may be together rotatable about the longitudinal centerline 12 by LP spool 36 across a power gear box 46. The power gear box 46 includes a plurality of gears for stepping down the rotational speed of the LP spool 36 to a more efficient rotational fan speed. In some approaches, the LP spool 36 may directly drive the fan without power gear box 46.

The power gear box 46 can include a plurality of gears, including an input and an output, and may also include one or more intermediate gears disposed between and/or interconnecting the input and the output. The input can comprise a first rotational speed and the output can have a second rotational speed. In some examples, a gear ratio of the first rotational speed to the second rotational speed is equal to or greater than 3.2 and equal to or less than 5.0 The power gear box 46 can comprise various types and/or configurations. In some examples, the power gear box 46 is a single-stage gear box. In other examples, the power gear box 46 is a multi-stage gear box. In some examples, the power gear box 46 is an epicyclic gearbox. In some examples, the power gear box 46 is a non-epicyclic gear box (e.g., a compound gearbox). More particularly, in some instances, the power gear box 46 is an epicyclic gear box configured in a star gear configuration. Star gear configurations comprise a sun gear, a plurality of star gears (which can also be referred to as “planet gears”), and a ring gear. The sun gear is the input and is coupled to the power turbine (e.g., the low-pressure turbine) such that the sun gear and the power turbine rotate at the same rotational speed. The star gears are disposed between and interconnect the sun gear and the ring gear. The star gears are rotatably coupled to a fixed carrier. As such, the star gears can rotate about their respective axes but cannot collectively orbit relative to the sun gear or the ring gear. As another example, the power gear box 46 is an epicyclic gear box configured in a planet gear configuration. Planet gear configurations comprise a sun gear, a plurality of planet gears, and a ring gear. The sun gear is the input and is coupled to the power turbine. The planet gears are disposed between and interconnect the sun gear and the ring gear. The planet gears are rotatably coupled to a rotatable carrier. As such, the planet gears can rotate about their respective axes and also collectively rotate together with the carrier relative to the sun gear and the ring gear. The carrier is the output and is coupled to the fan assembly. The ring gear is fixed from rotation.

Referring still to the exemplary embodiment of FIG. 1, the disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the variable pitch fan 38 and/or at least a portion of the core turbine engine 16. It should be appreciated that the outer nacelle 50 may be configured to be supported relative to the core turbine engine 16 by a plurality of circumferentially spaced outlet guide vanes 52. Moreover, a downstream section 54 of the outer nacelle 50 may extend over an outer portion of the core turbine engine 16 so as to define a bypass airflow passage 56 therebetween.

During operation of the gas turbine engine 10, a volume of air 58 enters the gas turbine engine 10 through an associated inlet 60 of the outer nacelle 50 and/or fan section 14. As the volume of air 58 passes across the fan blades 40, a first portion 62 of the air 58, as indicated by arrow 62, is directed or routed into the bypass airflow passage 56 and a second portion 64 of the air 58, as indicated by arrow 64, is directed or routed into the LP compressor 22. The ratio between the first portion 62 of air 58 and the second portion 64 of air 58 is commonly known as a bypass ratio. The pressure of the second portion 64 of air 58 is then increased as it is routed through the HP compressor 24 and into the combustion section 26, where it is mixed with fuel and burned to provide combustion gases 66. Subsequently, the combustion gases 66 are routed through the HP turbine 28 and the LP turbine 30, where a portion of thermal and/or kinetic energy from the combustion gases 66 is extracted.

The combustion gases 66 are then routed through the exhaust nozzle 32 of the core turbine engine 16 to provide propulsive thrust. Simultaneously, the pressure of the first portion 62 of air 58 is substantially increased as the first portion 62 of air 58 is routed through the bypass airflow passage 56 before it is exhausted from a fan nozzle exhaust section 76 of the gas turbine engine 10, also providing propulsive thrust.

It should be appreciated, however, that the gas turbine engine 10 depicted in FIG. 1 is by way of example only, and that in other exemplary embodiments, aspects of the present disclosure may additionally, or alternatively, be applied to any other suitable gas turbine engine. For example, in other exemplary embodiments, the gas turbine engine 10 may instead be any other suitable aeronautical gas turbine engine, such as a turbojet engine, turboshaft engine, turboprop engine, etc. Additionally, in still other exemplary embodiments, the gas turbine engine 10 may include or be operably connected to any other suitable accessory systems. Additionally, or alternatively, the exemplary gas turbine engine 10 may not include or be operably connected to one or more of the accessory systems discussed above.

The fan blades 40 of the gas turbine engine 10 may be made from a PMC material with metal leading edges to protect the airfoil from foreign objects, such as bird strikes. A polymer matrix composite (PMC) material for the airfoil can be more durable and/or exhibit improved performance when the airfoil is subjected to flutter effects during operation. In some embodiments, engines with fewer fan blades (e.g., less than 25 fan blades) and wider chords (c), such as engines having a blade count (BC) from 14 and 18, or 16 to 20 fan blades and ratios of chord to diameter (c/D) of greater than 0.17, or greater than 0.19, and less than 0.3 (e.g., less than 0.21) have the fan blade airfoil made from a PMC material with metal leading edge.

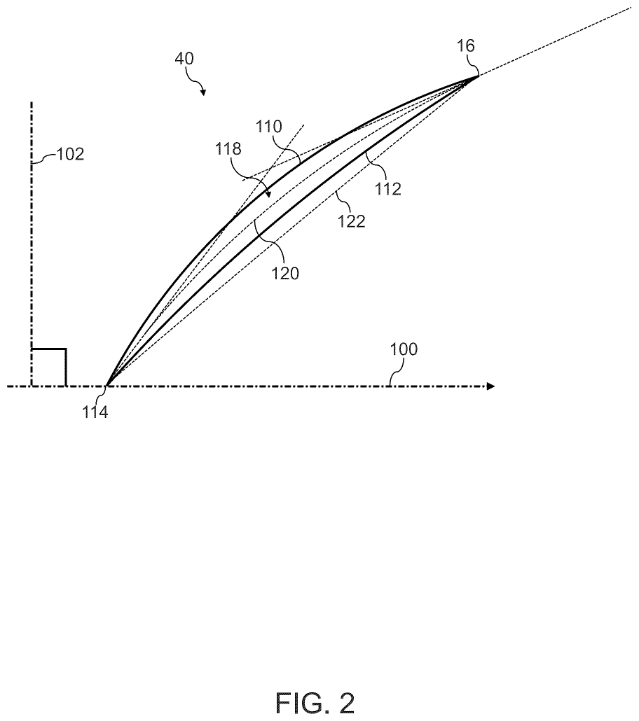

FIG. 2 is a sectional view of a fan blade 40 viewed radially (e.g., towards the rotation axis). A first axis 100 is parallel to the axial direction A of FIG. 1, and a second axis 102 is parallel to the circumferential direction 0.

Fan blade 40 includes a low-pressure surface 110 and an opposite high-pressure surface 112 that each extend between a proximal end 40a and a distal end 40b of the fan blade 40 (shown in FIG. 1). Fan blade 40 further includes a leading edge 114 and a trailing edge 116.

The low-pressure surface 110, high-pressure surface 112, leading edge 114, and trailing edge 116 form a profile 118 of the fan blade 40. The profile 118 defines a mean camber 120 that extends from the leading edge 114 to the trailing edge 116 and that is equidistant from the low-pressure surface 110 and the high-pressure surface 112.

The profile 118 further defines a local chord 122 (relative to a specific cross section through the blade) that represents a straight-line distance from the leading edge 114 to the trailing edge 116.

In some approaches, a fan blade 40 may have a profile 118 that varies along a radial height of the fan blade 40 between the proximal end 40a and the distal end 40b. For example, in some fan blade designs, a distance between the leading edge 114 and the trailing edge 116 may be greater at the proximal end 40a of the fan blade 40 than at the distal end 40b. As such, the length of the local chord 122 may vary along the radial height of the fan blade 40. In this way, an average chord line length may be derived for the fan blade that accounts for the variation in lengths of the local chord 122 along the radial height of the fan blade 40.

As mentioned earlier, the inventors have discovered relationships between timescales that include a fan pressure ratio, fan diameter, and corrected fan tip Mach number during the course of improving upon the fan module portion of various engine architectures. More particularly, and as discussed in greater detail below, the inventors have discovered relationships between ratio of axial flow timescales to rotation timescales, and suitable parameters for implementing those relationships with an engine.

The aircraft turbine engine architectures developed by the inventors include as major components a fan module and an engine core. The core includes one or more compressor stages and turbine stages. Compressor stages typically include high pressure and low pressure compressor stages, and turbines similarly include high and low pressure stages. The fan module that provides for an improved efficiency is not independent of these other parts of the engine, because there is always a trade benefit when one part is improved or modified. Improved efficiency brought by the fan can be in terms of a reduction in weight, lower installed drag, load balancing or management (dynamic or static loading), aerodynamic efficiency through the fan duct/interaction of fan to output guide vanes, and other factors. In an effort to improve upon what the fan can deliver (positive benefit of fan design) there often times need to be sacrifices in other parts of the engine (negative benefit of fan design). Or the benefits of a new fan design when viewed independent of a particular core design or airframe requirement, often times requires revision or is unrealistic given the impact that such a fan design will have on other parts of the engine, e.g., compressor operating margin, balance of a fan and output guide vanes (OGV) along with a power gearbox, and location of a low pressure compressor (packaging impacts). The teachings described herein are also applicable to other engine architectures such as electrically-driven fans (which may or may not include a turbine) and hybrid electrically-driven fans (e.g., distributed electric propulsion systems in which a gas turbine drives multiple fans).

The inventors, proceeding in the manner of designing improved fan modules, accounting for the trade-offs between fan module improvements and other potentially negative or limitations on fan module design, unexpectedly found certain relationships that define an improved fan design, now described in detail.

In one aspect, the inventors have discovered a relationship between an average fan chord “c”, a fan diameter “D” (e.g., a tip-to-tip dimension of the fan), a fan pressure ratio “FPR” of a fan, and a corrected redline fan tip Mach number “M_{tip,c}^{(RL)}” according to the below relationship, referred to herein as the First Performance Factor (“FPF”) for a fan module:

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 \qquad ( 1 )$$

$${m}_{1} \cdot [ {M}_{tip , c}^{( RL )} - 1.1 ] + 6 > FPF > {m}_{1} \cdot [ {M}_{tip , c}^{( RL )} - 1.1 ] + Δ {y}_{1} \qquad ( 2 )$$

The ratio of average fan chord “c” to fan diameter “D” is a nondimensionalized chord width ratio greater than 0.1 (e.g., greater than 0.15, greater than 0.17, or greater than 0.19), and less than 0.3 (e.g., less than 0.21).

As used herein, the “fan pressure ratio” (FPR) refers to a ratio of a stagnation pressure immediately downstream of the plurality of outlet guide vanes 52 during operation of the fan 38 to a stagnation pressure immediately upstream of the plurality of fan blades 40 during the operation of the fan 38. The “\sqrt{FPR−1}” portion of the average fan chord relationship may be utilized as a surrogate for referencing a proportionality to the increase in axial flow velocity through the fan. The fan pressure ratio is greater than 1.2 (e.g., greater than 1.3), and less than 1.5 (e.g., less than 1.45, less than 1.42, or less than 1.4).

As used herein, “M_{tip,c}^{(RL)}”, is a corrected fan tip Mach number at redline (e.g., maximum permissible rotational speed of the fan at a redline shaft speed, which is either directly coupled to the fan or through a reduction gearbox). “Fan tip speed” refers to a linear speed of an outer tip of a fan blade 40 during operation of the fan 38. “Corrected fan tip speed” (referred to as “U_{tip,c}”) may be provided, for example, as ft/sec divided by an industry standard temperature correction. In an example approach, U_{tip,c} may be less than 1,500 ft/sec (e.g., less than 1,250 ft/sec or less than 1,100 ft/sec), and greater than 500 ft/sec. “Corrected fan tip Mach number” refers to a nondimensionalized value obtained by dividing U_{tip,c} by the generally accepted speed of sound at standard day sea level atmospheric conditions (i.e., 1,116.45 ft/sec). As such, M_{tip,c}^{(RL)} may be less than 1.34 (e.g., less than 1.12 or less than 0.99), and greater than 0.45.

FPF, as defined in (1), may be thought of as representing a ratio of speeds. When considered with the normalized chord width “c/D,” FPF may be thought of as a correlation of timescales of the blade rotation with the time taken for a flow particle to traverse a fan average chord length when the engine is operating at static conditions.

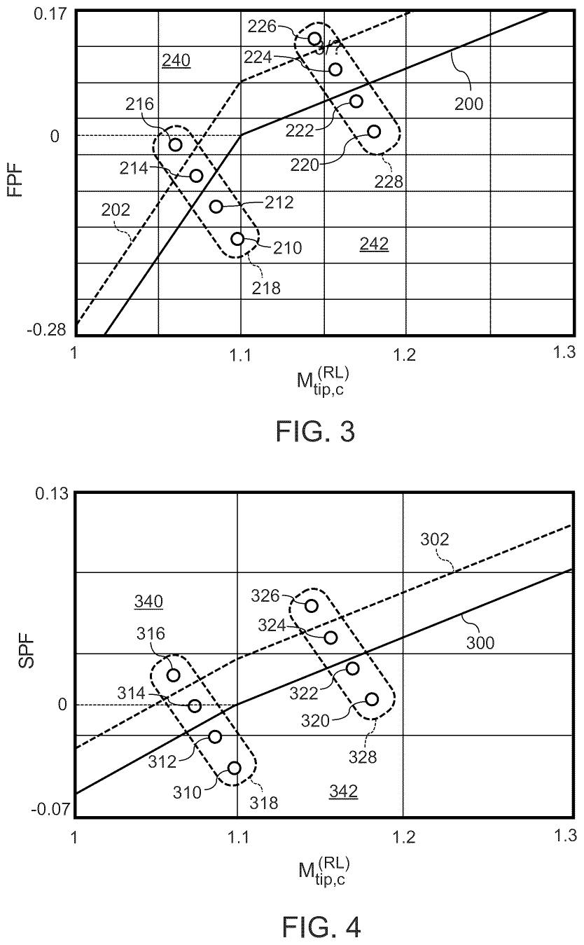

Referring to the inequality defined in (2) and to the plot of FIG. 3, example engine embodiments are shown having unique FPF values and corresponding redline corrected fan tip Mach number (M_{tip,c}^{(RL)}. FPF increases in value along the Y-axis, while the X-axis represents left-to-right increasing redline corrected fan tip Mach number (M_{tip,c}^{(RL)}). FIG. 3 also shows a first line 200 and a second line 202 that is offset from the first line 200 along the Y-axis. The first and second lines 200, 202 are defined by the “m₁·[M_{tip,c}^{(RL)}−1.1]+Δy₁” portion of inequality (2). As used herein, “m₁” refers to a slope of a line 200, 202, “1.1” refers to a reference corrected redline tip Mach number at which Y-intercept is defined in the FPF, and Δy₁ refers an offset from the Y-intercept along the Y-axis.

As shown in FIG. 3, the first and second lines 200, 202 are piecewise linear dividing curves; i.e., the first and second lines 200, 202 have different slopes “m₁” depending on the M_{tip,c}^{(RL)} along the X-axis. More particularly, when the value of M_{tip,c}^{(RL)} is equal to or greater than 1.1, the first and second lines 200, 202 have slopes “m₁” equal to 0.87. When the value of M_{tip,c}^{(RC)} is less than 1.1, the first and second lines 200, 202 have slopes “m₁” equal to 3.34. While depicted as piecewise linear dividing curves, the low-speed scaling is actually nonlinear and there are advantages to lower c/D designs toward the lower portion of the plot of FIG. 3 associated with lower FPR and lower M_{tip,c}^{(RL)}.

As discussed, Δy₁ refers an offset from the Y-intercept along the Y-axis. The Δy₁ value can be 0.0125, 0.04, 0.07, 0.1, or 0.2, or can vary between 0 and 6, 0 and 0.0125, 0.0125 and 0.04, 0.04 and 0.07, 0.07 and 0.1, 0.1 and 0.2, or a value greater than 0.2 and less than 6.

FIG. 3 shows eight example engine embodiments, of which gas turbine engines 210, 212, 214, 216 may be referred to as low speed engine designs (as indicated by subplot area 218), and engines 220, 222, 224, 226 may be referred to as high speed engine designs (as indicated by subplot area 228). Each of the gas turbine engines 210, 212, 214, 216, 220, 222, 224, 226 have a gear ratio in a range equal to or greater than 3.2 and less than or equal to 5.0.

As represented by the FPF, which indicates a particular fan chord relationship, the inventors discovered a limited or narrowed selection of average fan chords that uniquely take into consideration other factors associated with the fan and engine type. For instance, the inventors determined that an engine having an FPF value for a given M_{tip,c}^{(RL)} value above line 200 (within plot area 240) may allow for relatively wider chord widths as compared to engines having an FPF value for a given M_{tip,c}^{(RL)} value below line 200 (within plot area 242). In this way, gas turbine engines 214, 216, 224, and 226 may provide advantages over gas turbine engines 210, 212, 220, and 222, such as a reduced fan blade count (discussed in greater detail below), increased aeromechanical stability and reduced fan lift coefficient C_{L} during takeoff of the aircraft. In some instances, such advantages may become more pronounced as FPF increases and M_{tip,c}^{(RL)} value decreases (for next generation ultra-high bypass ratio engines for instance). For example, the improvement in engine performance based on the redline tip Mach number may have FPF values greater than m₁·[M_{tip,c}^{(RL)}−1.1]+0.0125, greater than m₁·[M_{tip,c}^{(RL)}−1.1]+0.04, greater than m₁·[M_{tip,c}^{(RL)}−1.1]+0.07, greater than m₁·[M_{tip,c}^{(RL)}−1.1]+0.1, or greater than m₁·[M_{tip,c}^{(RL)}−1.1]+0.2 (these other examples are schematically represented by the phantom line 202).

In another aspect, the inventors have discovered a relationship between a fan blade count “BC”, a hub-to-tip ratio of a fan “HTR”, a fan pressure ratio “FPR” of a fan, and a corrected redline fan tip Mach number “M_{tip,c}^{(RL)}” according to the below relationship, referred to herein as the Second Performance Factor (“SPF”) for a fan module:

$$SPF = \sqrt{\frac{π}{4} ( 1 - {HTR}^{2} ) / ( \frac{BC}{20} )} / ( \frac{\sqrt{FPR - 1}}{\sqrt{0.4}} ) / {M}_{tip , c}^{( RL )} - 0.97 \qquad ( 3 )$$

$${m}_{2} \cdot [ {M}_{tip , c}^{( RL )} - 1.1 ] + 1.5 > SPF > {m}_{2} \cdot [ {M}_{tip , c}^{( RL )} - 1.1 ] + Δ {y}_{2} \qquad ( 4 )$$

Regarding the hub-to-tip ratio “HTR,” a fan blade defines a hub radius (R_{hub}), which is the radius of the leading edge at the hub relative to a centerline of the fan, and a tip radius (Rₜᵢₚ), which is the radius of the leading edge at a tip of the fan blade relative to the centerline of the fan. HTR is the ratio of the hub radius to the tip radius (R_{hub}/Rₜᵢₚ). The ratio is greater than 0.1 and less than 0.5 (e.g., less than 0.275, less than 0.25, or less than 0.225).

Blade count “BC” corresponds to the number of fan blades circumferentially arranged about the fan hub. The blade count is between 10 fan blades and 40 fan blades. In certain example approaches, the blade count is less than or equal to 18 fan blades (e.g., 16 or fewer fan blades).

“FPR” and “M_{tip,c}^{(RL)}” refer to a fan pressure ratio and a redline corrected fan tip Mach number, respectively, as discussed with respect to the average fan chord relationship above. In this way, the values of one or more of the FPR and “M_{tip,c}^{(RL)}”, may be the same as those discussed with respect to the average fan chord relationship.

Referring to the inequality defined in (4) and to the plot of FIG. 4, example engine embodiments are shown having unique SPF values and corresponding redline corrected fan tip Mach number (M_{tip,c}^{(RL)}). SPF increases in value along the Y-axis, while the X-axis represents left-to-right increasing redline corrected fan tip Mach number (M_{tip,c}^{(RL)}). FIG. 4 also shows a first line 300 and a second line 302 that is offset from the first line 300 along the Y-axis. The first and second lines 300, 302 are defined by the “m₂·[M_{tip,c}^{(RL)}−1.1]+Δy₂” portion of inequality (4).

As shown in FIG. 4, the first and second lines 300, 302 are piecewise linear dividing curves; i.e., the first and second lines 300, 302 have different slopes “m₂” depending on the M_{tip,c}^{(RL)} long the X-axis. More particularly, when the value of M_{tip,c}^{(RL)} is equal to or greater than 1.1, the first and second lines 300, 302 have slopes “m₂” equal to 0.41. When the value of M_{tip,c}^{(RL)} is less than 1.1, the first and second lines 300, 302 have slopes “m₂” equal to 0.55.

As used herein, “m₂” refers to a slope of a line 300, 302, which as shown, is equal to 1. “1.1” refers to a reference corrected redline tip Mach number at which the Y-intercept is defined, and Δy₂ refers an offset from the Y-intercept along the Y-axis. The Δy₂ value can be 0.0075, 0.01, 0.02, 0.024, 0.037, 0.04, or 0.06, or can vary between 0 and 1.5, 0 and 0.0075, 0.0075 and 0.01, 0.01 and 0.2, 0.2 and 0.024, 0.024 and 0.037, 0.037 and 0.04, 0.04 and 0.6, or a value greater than 0.6 and less than 1.5.

FIG. 4 shows eight example engine embodiments, of which gas turbine engines 310, 312, 314, 316 may be referred to as low speed engine designs (as indicated by subplot area 318), and engines 320, 322, 324, 326 may be referred to as high speed engine designs (as indicated by subplot area 328). Each of the gas turbine engines 310, 312, 314, 316, 320, 322, 324, 326 have a gear ratio a range equal to or greater than 3.2 and less than or equal to 5.0.

As represented by the SPF, which indicates a particular fan blade count relationship, the inventors discovered a limited or narrowed selection of fan blade count that uniquely take into consideration other factors associated with the fan and engine type. For instance, the inventors determined that an engine having an SPF value for a given M_{tip,c}^{(RL)} value above line 300 (within plot area 340) may allow for reduced fan blade counts as compared to engines having an SPF value for a given M_{tip,c}^{(RL)} value below line 300 (within plot area 342). In this way, gas turbine engines 314, 316, 324, and 326 may provide advantages over gas turbine engines 310, 312, 320, and 322, such as a reduced cost and weight. In some instances, such advantages may become more pronounced as the SPF value increases and the M_{tip,c}^{(RL)} value decreases (for next generation ultra-high bypass ratio engines for instance). For example, the improvement in engine performance based on the redline tip Mach number may have SPF values greater than m₂·[M_{tip,c}^{(R)}−1.1]+0.0075, greater than m₂·[M_{tip,c}^{(RL)}−1.1]+0.01, greater than m₂·[M_{tip,c}^{(RL)}−1.1]+0.02, greater than m₂·[M_{tip,c}^{(RL)}−1.1]+0.024, greater than m₂·[M_{tip,c}^{(RL)}−1.1]+0.037, greater than m₂·[M_{tip,c}^{(RL)}−1.1]+0.04, or greater than m₂·[M_{tip,c}^{(RL)}−1.1]+0.06 (these other examples are schematically represented by the phantom line 302).

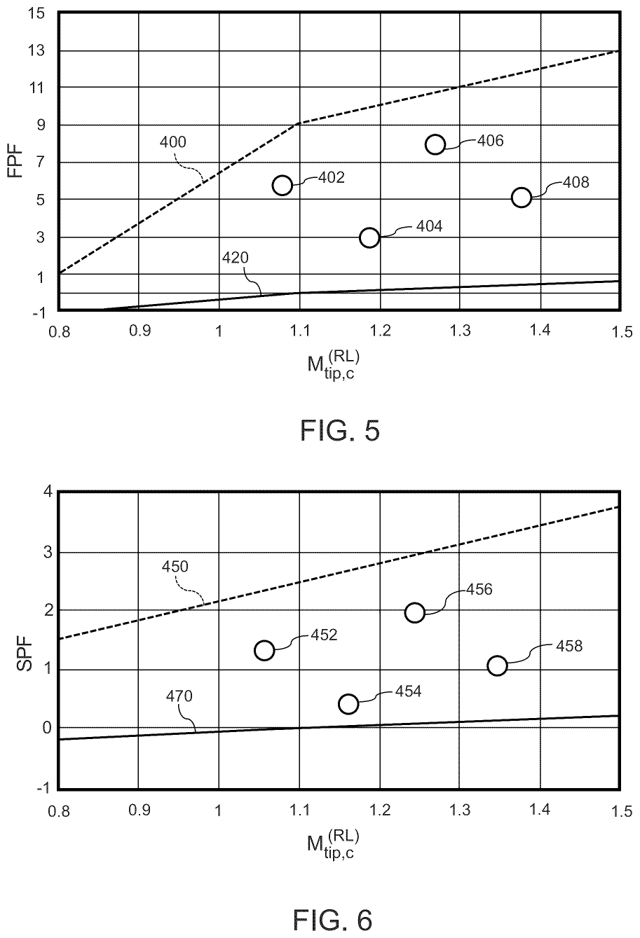

FIG. 5 shows additional example engine embodiments 402, 404, 406, 408 having First Performance Factor (FPF) values, as similarly described herein. Line 400 is a piecewise linear dividing curve having different slopes “m₁” depending on the M_{tip,c}^{(RL)} along the X-axis. More particularly, when the value of M_{tip,c}^{(RL)} is equal to or greater than 1.1, line 400 has a slope “m₁” equal to 9.43. When the value of M_{tip,c}^{(RL)} is less than 1.1, line 400 has a slope “m₁” equal to 27.02.

Line 420 corresponds to line 200 of FIG. 3 and is similarly a piecewise linear dividing curve having different slopes “m₂” depending on the M_{tip,c}^{(RL)} along the X-axis. As with FIG. 3, when the value of M_{tip,c}^{(RL)} is equal to or greater than 1.1, the line 420 has a slope “m₂” equal to 0.87. When the value of M_{tip,c}^{(RL)} is less than 1.1, M_{tip,c}^{(RL)} line 420 has a slope “m₂” equal to 3.34.

In this approach, the First Performance Factor (FPF) is as provided:

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 \qquad ( 5 )$$

$${m}_{1} \cdot [ {M}_{tip , c}^{( RL )} - 1.1 ] + 9.14 > FPF > {m}_{2} \cdot [ {M}_{tip , c}^{( RL )} - 1.1 ] \qquad ( 6 )$$

The First Performance Factor (FPF) values may be in the range, for example, equal to or greater than −0.8 and equal to or less than 8.4, equal to or greater than 0 and equal to or less than 6, or equal to or greater than 1 and equal to or less than 2. M_{tip,c}^{(RL)} values may be within a range equal to or greater than 0.8 and equal to or less than 1.5, or equal to or greater than 0.9 and equal to or less than 1.4. FPR values may be within a range equal to or greater than 1.2 and equal to or less than 1.6, equal to or greater than 1.3 and equal to or less than 1.5, or equal to or greater than 1.35 and equal to or less than 1.45.

FIG. 6 shows additional example engine embodiments 452, 454, 456, 458 having Second Performance Factor (SPF) values, as similarly described herein. Line 450 is a linear curve having slope “m₃” of 3.17. Line 470 corresponds to line 300 of FIG. 4 and is similarly a piecewise linear dividing curve having different slopes “m₄” depending on the M_{tip,c}^{(RL)} along the X-axis. More particularly, when the value of M_{tip,c}^{(RL)} is equal to or greater than 1.1, line 470 has a slope “m₄” equal to 0.41. When the value of M_{tip,c}^{(RL)} is less than 1.1, line 420 has a slope “m₄” equal to 0.55.

In this approach, the Second Performance Factor (SPF) is as provided:

$$SPF = \sqrt{\frac{π}{4} {( 1 - HTR )}^{2} / ( \frac{BC}{20} )} / ( \frac{\sqrt{FPR - 1}}{\sqrt{0.4}} ) / {M}_{tip , c}^{( RL )} - 0.97 \qquad ( 7 )$$

$${m}_{3} \cdot [ {M}_{tip , c}^{( RL )} - 1.1 ] + 2.52 > SPF > {m}_{4} \cdot [ {M}_{itp , c}^{( RL )} - 1.1 ] \qquad ( 8 )$$

The Second Performance Factor (SPF) values may be in the range, for example, equal to or greater than 0.087 and equal to or less than 2.4, or equal to or greater than 1 and equal to or less than 2. M_{tip,c}^{(RL)} values may be within a range equal to or greater than 0.8 and equal to or less than 1.5, or equal to or greater than 0.9 and equal to or less than 1.4. HTR values may be within a range equal to or greater than 0.2 and equal to or less than 0.4, or equal to or greater than 0.25 and equal to or less than 0.35.

The inventors have discovered a relationship between the First Performance Factor and Second Performance Factor described herein. More particularly, the inventors discovered that engine designs achieving each of the First Performance Factor and Second Performance Factor, without significant changes in solidity, provide improved engine performance. Blade solidity is defined as the ratio of the blade chord length to the distance of space between the blades.

Example engine parameters and corresponding First Performance Factors and Second Performance Factors are presented in Table 1 below.

TABLE 1

| Example | HTR | FPR | M_{tip, c}^{(RL)} | SPF | FPF |
|---|---|---|---|---|---|
| 1 | 0.206 | 1.522 | 1.417 | 1.782 | 2.374 |
| 2 | 0.400 | 1.376 | 1.421 | 0.981 | 0.976 |
| 3 | 0.260 | 1.204 | 1.177 | 0.823 | 2.722 |
| 4 | 0.224 | 1.595 | 0.976 | 0.646 | −0.359 |
| 5 | 0.213 | 1.517 | 0.815 | 0.613 | −0.823 |
| 6 | 0.265 | 1.448 | 1.497 | 1.152 | 1.161 |
| 7 | 0.352 | 1.250 | 0.962 | 0.087 | −0.445 |
| 8 | 0.394 | 1.328 | 1.228 | 2.403 | 6.606 |
| 9 | 0.213 | 1.517 | 0.815 | 0.613 | −0.823 |
| 10 | 0.235 | 1.240 | 1.231 | 2.053 | 8.398 |

In this way, using fan parameters such as fan pressure ratios, corrected fan tip Mach number, fan diameters, and hub-to-tip ratios, the inventors discovered approaches that utilize the above-described average fan chord relationship to obtain an average chord width, and the above-described fan blade count relationship to obtain a fan blade count. These obtained constraints guide one to select fan chord width, blade count, or both suited for the particularized engine architectures and mission requirements, informed by engine-unique environments and trade-offs in design (as discussed above), which are believed to result in an improved engine.

In another aspect, the FPF and SPF may also be useful as a design tool for down-selecting, or providing a guideline for reducing the number of candidate designs for fan blade counts and average fan chords from which to design a fan module for a particular architecture. In this way, an engine architecture is improved overall by knowing, early in the design process, what constraints or limitations would be imposed by a fan module given the mission objectives.

In another aspect method of assembly is provided. The method includes mounting a fan inside an annular casing for rotation about an axial centerline. The fan including fan blades that extend radially outwardly toward the annular casing. The fan further includes an average fan chord width according to the First Performance Factor (“FPF”) and/or a quantity of fan blades according to the Second Performance Factor (“SPF”) discussed above.

As disclosed herein, fan parameters such as fan pressure ratios, corrected fan tip speeds, fan diameters, and hub-to-tip ratios may be used to select a fan chord width, a blade count, or both to provide a gas turbine engine having improved engine aerodynamic efficiency and/or improved fuel efficiency. The gas turbine engine also includes a plurality of rotating airfoils and stationary airfoils which are subject to impinging wakes and vortices generated from an upstream object, such as an upstream blade row, or an input unsteady airflow. The upstream generated wakes and vortices are channeled downstream where they may impinge on the leading edge of downstream airfoils. During the course of designing a more efficient gas turbine engine, it was found that designing airfoils having a three-dimensional waveform can further improve engine aerodynamic efficiency and fuel efficiency while reducing aerodynamic noise and aeromechanical loading.

In particular embodiments, the gas turbine engine includes at least one airfoil having a plurality of first chord sections and a plurality of second chord sections. Each first chord section may be radially-spaced a distance away from an immediately adjacent second chord section. Additionally, at least one first chord section may be formed with a chord length that is longer than a chord length of at least one second chord section thereby defining a waveform along a leading edge of the airfoil. An airfoil having a plurality of waves along the leading edge reduces the magnitude of the airfoil unsteady pressure response to wakes and vortices impinging on the leading edge of the airfoil such that the noise and aeromechanical loading are reduced, thereby increasing engine efficiency and performance, reducing radiated noise, and reducing aeromechanical loading without increasing blade or vane weight and without decreasing aerodynamic performance.

The airfoil having a leading edge defining a waveform as set forth above was moreover found to be particularly advantageous for the gas turbine engine contemplated by the above relationships (1) through (4) to further improve performance of the gas turbine engine. For example, a larger ratio of chord to diameter (c/D) and a lower blade count (BC) may drive the distance of space between the blades closer together, which may create unwanted noise. However, by including the waveform on the leading edge of the airfoil, as discussed herein, such noise is reduced and lower acoustic noise requirements may be satisfied. Additionally, the waveform reduces the severity of rotating pulse from the fan blade. Reducing such vibratory forces enables a smaller fan design while also providing aerodynamic efficiency and reducing fatigue. Accordingly, providing an airfoil having a leading edge defining a waveform in combination with the relationships (1) through (4) disclosed herein synergistically results in a gas turbine engine having improved aerodynamic efficiency, improved fuel efficiency, and reduced noise levels.

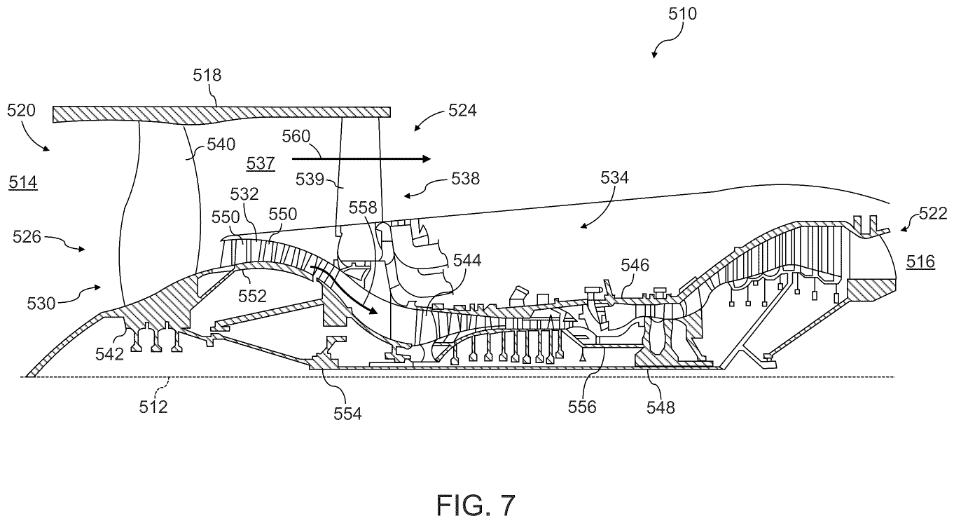

FIG. 7 is a schematic illustration of an exemplary gas turbine engine 510 having a longitudinally extending axis 512 that extends through the gas turbine engine 510 from front to back (from left to right on FIG. 7). Flow through the illustrated exemplary engine is generally from front to back. The direction parallel to the centerline toward the front of the engine and away from the back of the engine will be referred to herein as the “upstream” direction 514, while the opposite direction parallel to the centerline will be referred to herein as the “downstream” direction 516.

The gas turbine engine 510 has an outer shell, or nacelle 518, that generally defines the engine. The gas turbine engine 510 also includes an intake side 520, a core engine exhaust side 522, and a fan exhaust side 524. The intake side 520 includes an intake 526 located at front opening of the nacelle 518, and flows into the engine enters through the intake 526. The fan exhaust side 524 includes an exhaust, or nozzle, (not shown) located at the aft end of the nacelle 518. Flow exits the gas turbine engine 510 from the exhaust.

A core engine is disposed inside the nacelle 518 and includes a fan assembly 530, a booster compressor 532, a core gas turbine engine 534, and a low-pressure turbine 536 that is coupled to the fan assembly 530 and the booster compressor 532. The fan assembly 530 includes a plurality of rotor fan blades 540 that extend substantially radially outward from a fan rotor disk 542. The core gas turbine engine 534 includes a high-pressure compressor 544, a combustor 546, and a high-pressure turbine 548. The booster compressor 532 includes a plurality of rotor blades 550 that extend substantially radially outward from a compressor rotor disk 552 coupled to a first drive shaft 554. The high-pressure compressor 544 and the high-pressure turbine 548 are coupled together by a second drive shaft 556.

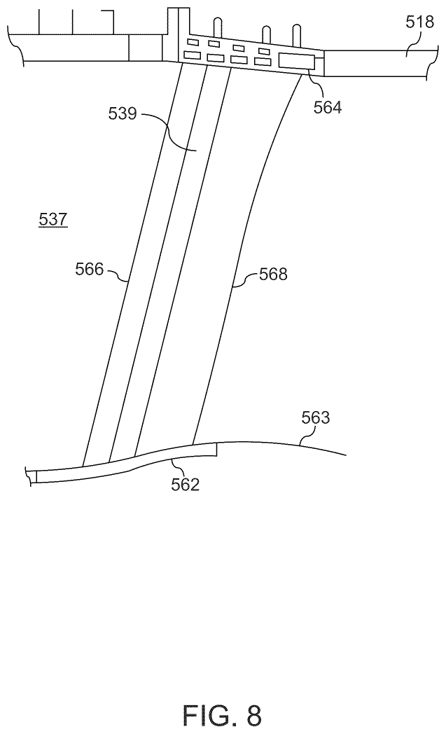

During operation, air entering the gas turbine engine 510 through the intake side 520 is compressed by the fan assembly 530. The airflow exiting the fan assembly 530 is split such that a portion of the airflow, and more particularly a compressed airflow 558 is channeled into the booster compressor 532 and a remaining portion 560 of the airflow bypasses the booster compressor 532 and the core gas turbine engine 534 and exits the gas turbine engine 510 through a stationary vane row, and more particularly an outlet guide vane assembly 538, comprising a plurality of airfoil guide vanes 539, at the fan exhaust side 524. More specifically, a circumferential row of radially extending airfoil guide vanes 539 are utilized adjacent fan assembly 530 to exert some directional control of the airflow 560. One such airfoil guide vane is illustrated in FIG. 8. The plurality of rotor blades 550 compress and deliver the compressed airflow 558 towards the core gas turbine engine 534. The airflow 558 is further compressed by the high-pressure compressor 544 and is delivered to the combustor 546. The airflow 558 from the combustor 546 drives the rotating turbines 536 and 548 and exits the gas turbine engine 510 through the core engine exhaust side 522.

Referring to FIG. 8, the stationary guide vane is illustrated, and more particularly the airfoil guide vane 539 configured as one of a circumferential row of radial guide vanes extending across an annular space 537 of FIG. 7 from a central circumferential part 562 of an engine casing 563 to engage a circumferential part 564 at the engine fan casing, or nacelle, 518. Central circumferential parts 562 and 564 may be circular rim or band structures or arcuate segments thereof referred to as vane support platforms. In a final outlet guide vane assembly 538, circumferential part 564 comprises a plurality of adjacent vane platform segments (not shown) which together form the outer ring structure or part 564 to support a circular row of the radially extending airfoil guide vanes 539. The airfoil guide vane 539 includes an airfoil leading edge 566 and an airfoil trailing edge 568.

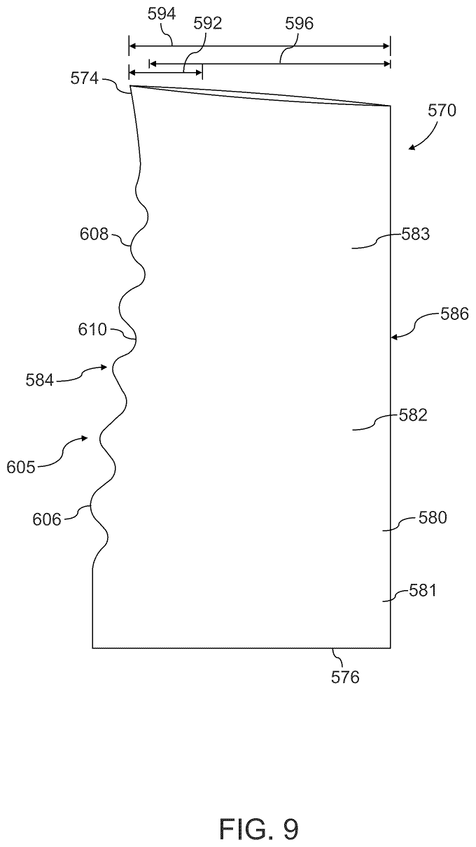

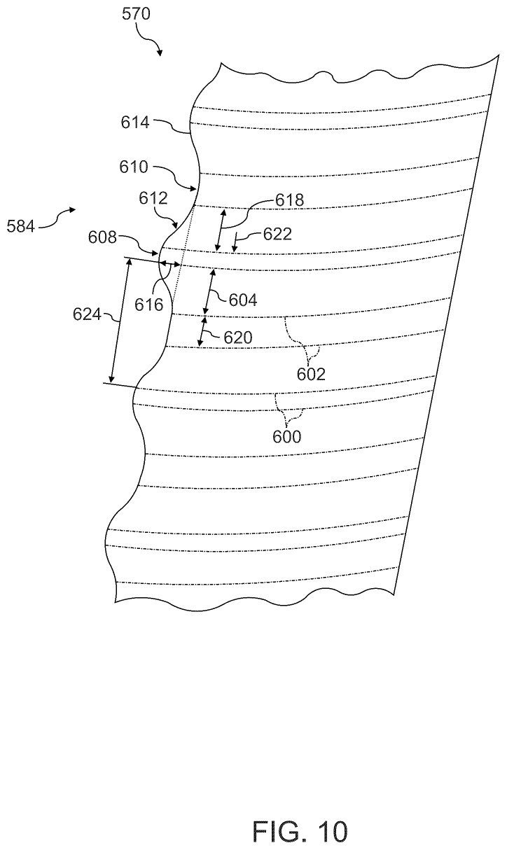

FIG. 9 illustrates a perspective view of an example embodiment of an airfoil 570, and more particularly an outlet guide vane, generally similar to the airfoil guide vane 539 of FIGS. 7 and 8 that may be used in an engine assembly, generally similar to the gas turbine engine 510 of FIG. 7. FIG. 10 illustrates an enlarged view of a portion of the exemplary airfoil 570. In at least one example embodiment, the airfoil 570 includes a tip portion 574, and a root portion 576. Alternatively, the airfoil 570 may be used with, but not limited to, rotor blades, and/or stator vanes/blades. The airfoil 570 includes a first side, and more specifically a first contoured sidewall 580 and a second side, and more specifically a second contoured sidewall 582. Specifically, in an embodiment, the first contoured sidewall 580 defines a pressure side 581 of the airfoil 570, and the second contoured sidewall 582 defines a suction side 583 of the airfoil 570. The sidewalls 580 and 582 are coupled together at a leading edge 584 and at a trailing edge 586 spaced one of axially or chord wise in a downstream direction from the leading edge 584. The trailing edge 586 is spaced chord-wise and downstream from the leading edge 584. The pressure side 581 and the suction side 583, and more particularly first contoured sidewall 580 and second contoured sidewall 582, respectively, each extend outward spanwise, from the root portion 576 to the tip portion 574.

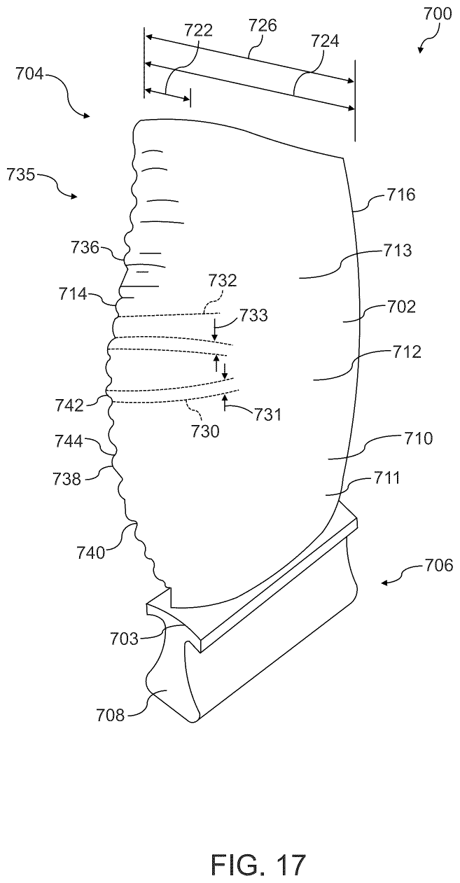

In at least one example embodiment, because of its design, and as explained in more detail below, the airfoil 570 includes a plurality of first chord sections 600 and a plurality of second chord sections 602, as shown in FIG. 4. The first chord sections 600 and the second chord sections 602 extend generally chord-wise between the leading edge 584 and the trailing edge 586. As described in more detail below, each first chord section 600 is radially-spaced a distance 604 away from an immediately adjacent second chord section 602. In an example embodiment, at least one first chord section 600 is formed with a first chord length 594 that is longer than a second chord length 596 of at least one second chord section 602 thereby defining a waveform 605, defined by plurality of waves 606, along the leading edge 584 as illustrated in FIG. 3. Specifically, in an example embodiment, each first chord section 600 defines a wave tip 608 along the leading edge 584. Similarly, each second chord section 602 defines a wave trough 610 along the leading edge 584. As a result, in an embodiment, the plurality of alternating first chord sections 600 and second chord sections 602, define the waves 606, and thus the wave-like pattern or waveform 605 extending along the leading edge 584. In an alternate embodiment, the at least one first chord section 600 and the at least one second chord section 602 are formed having a first chord length 594 and a second chord length 596, respectively, that are of equal length as described with respect to FIG. 17, and including at least one of a camber, thickness, or stacking wave defined by spanwise stacking of the first chord sections 600 and second chord sections 602 relative to each other.

In an embodiment, the waves 606 each include a radial inner edge 614 and a radial outer edge 612. Moreover, the leading edge 584 is defined by the plurality of wave tips 608 and by the plurality of wave troughs 610. More specifically, each wave tip 608 is defined on a respective first chord section 600. Similarly, each wave trough 610 is defined on a respective second chord section 602. As a result, in an embodiment, each wave tip 608 extends, in a chord-wise direction, a distance 616 upstream from each wave trough 610. Moreover, in an embodiment, each radial inner edge 614 and radial outer edge 612 extends generally radially between a wave tip 608 and a wave trough 610.

In at least one example embodiment, the number of alternating adjacent first chord sections 600 and second chord sections 602 determines the number of waves 606 defined along the leading edge 584. Specifically, in an example embodiment, each second chord section 602 is separated by a distance 618 from each first chord section 600, measured with respect to the radial outer edge 612. Similarly, in an example embodiment, each first chord section 600 is separated by a distance 604 from each second chord section 602 measured with respect to the radial inner edge 614. Alternatively, the distances 604 and 618 may be substantially zero such that the radially inner and outer edges 612 and 614, respectively, extend substantially chord-wise between the wave tip 608 and the wave trough 610. In an example embodiment, the distances 604 and 618 are approximately equal. In an alternative exemplary embodiment, the distance 604 may not be equal to the distance 618. In such an embodiment, the partial spanwise wavelength 604 of the radial inner edge 614 is not substantially equal to the partial spanwise wavelength 618 of the radial outer edge 612. In another example embodiment, the radial inner edge 614 and the radial outer edge 612 may have any plan shape that extends between the wave tip 608 and the wave trough 610 including, but not limited to, a straight edge and a sinusoidal edge. The waves 606 may be designed to maintain an appropriate local average chord, camber and stacking (e.g., dihedral) such that the aerodynamic performance of airfoil 570 is not penalized.

In some example embodiments, the waves 606 extend in a span-wise direction from the root portion 576 to the tip portion 574 on the leading edge 584 of the airfoil 570. In an alternative embodiment, the waves 606 may only partially extend in a span-wise direction along the leading edge 584 of the airfoil 570 (described presently). In another embodiment, the airfoil 570 may include at least one group of waves 606 extending at least partially, in a span-wise direction, along the airfoil 570 (described presently).

As shown in FIG. 4, the wave trough portion 610 has a length 620 that extends generally along the leading edge 584. Similarly, in an embodiment, the wave tip portion 608 has a length 622 that extends generally along the leading edge 584. Alternatively, the length 620 of the wave trough 610 may be substantially zero such that the wave trough 610 is substantially a transition point defined between the radial inner edge 614 and the radial outer edge 612. In another embodiment, the length 622 may be substantially zero such that the wave tip 608 is substantially a transition point defined between the radial inner edge 614 and the radial outer edge 612.

The plurality of waves 606 are each fabricated with a pre-determined aspect ratio that represents a ratio of distance 616 with respect to a tip-to-tip distance 624. In an embodiment, the distance 616 is the distance between the first chord length 594 (shown in FIG. 9) and the second chord length 596 (shown in FIG. 9). In an embodiment, distance 616 may be substantially zero where only a camber wave is included.

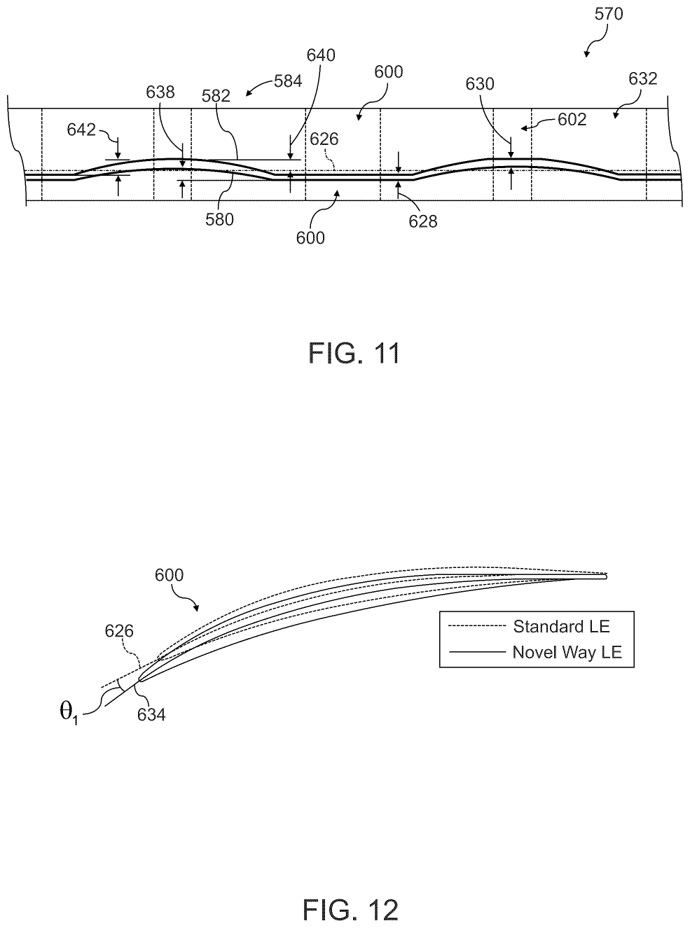

With reference to FIGS. 11-13, FIG. 11 is a cross-sectional end view of a portion of the leading edge 584 of the airfoil 570 of FIG. 9. FIGS. 12 and 13 illustrate cross-sectional span-wise views of the airfoil 570 taken through a long chord section 600 and a short chord section 602, respectively as compared to a standard leading edge airfoil. In an example embodiment, the airfoil 570 is also formed with a mean camber line 626 extending in a chord-wise direction from the leading edge 584 to the trailing edge 586, such that the mean camber line 626 is equidistant from both the first contoured wall 580 or the pressure side 581 and the second contoured sidewall 582 or the suction side 583. In an embodiment, the airfoil 570 also has a thickness measured between the first contoured sidewall 580 and the second contoured sidewall 582. Specifically, in an example embodiment, the airfoil 570 has a first chord thickness 628 defined on at least one first chord section 600, and a second chord thickness 630 defined on at least one second chord section 602. In an embodiment, the first chord thickness 628 is greater than the second chord thickness 630. Additionally, in an embodiment, the second chord thickness 630 is wider than the first chord thickness 628. The airfoil 570 has formed a plurality of camber waves 632, defined hereafter by both airfoil camber in the stream wise direction and/or stacking in the spanwise direction, in a span-wise direction defined substantially between the leading edge 584 and trailing edge, thereby defining a three-dimensional crenulated airfoil 570.

In at least one example embodiment, such as shown in FIG. 11, the first chord sections 600 and the second chord sections 602 are each formed with a respective camber line 634 and 636 at leading edge 584 with respect to the airfoil mean camber line 626. More specifically, the first chord camber line 634 is oriented at an angle θ₁ with respect to the mean camber line 626. The orientation of the first chord camber line 634 causes the wave tip 608 to extend a distance 638 into a flow path (not shown) of one of the first contoured sidewall 580, the pressure side 581, or the second contoured sidewall 582, or the suction side 583, wherein the distance 638 is measured between the mean camber line 626 and the first contoured sidewall 580. Similarly, the second chord camber line 636 is oriented at an angle θ₂ with respect to mean camber line 626. The orientation of the second chord camber line 636 causes the wave trough 610 to extend a distance 640 into a flow path (not shown) of one of the first contoured sidewall 580, the pressure side 581, or the second contoured sidewall 582, or the suction side 583, wherein a distance 640 is measured between the mean camber line 626 and the second contoured sidewall 582. At certain operating conditions of interest, the chord variations introduced by the wavy leading edge features may cause high flow acceleration at the leading edge (referred to herein as a leading edge suction peak) of the second chord section 602 due to the aerodynamic influence of the adjacent first chord sections 600. This flow acceleration may limit the effectiveness of the wavy leading edge and possibly cause a detrimental effect on noise. Hence, it is essential to mitigate the leading edge suction peak of the second chord section 602 via appropriate design. In at least one example embodiment, as shown in FIGS. 12 and 13, to mitigate the leading edge suction peak of the second chord section 602, the wavy leading edge of the first chord section 600 and the second chord section 602 may be oriented downward with respect to a standard leading edge airfoil as shown in dotted line and may include a curvature near the wavy leading edge that is greater than that of an airfoil including the standard leading edge. Configuring the first chord sections 600 and second chord sections 602 accordingly minimizes leading edge suction peak and leads to desensitization of airfoil unsteady pressure response to impinging wakes and vortices, resulting in a decrease in generated noise. It is obvious to one skilled in the art that alternate embodiments of mitigating the high leading edge flow acceleration may also be accomplished via other geometric design parameters, such as through thickness modifications.

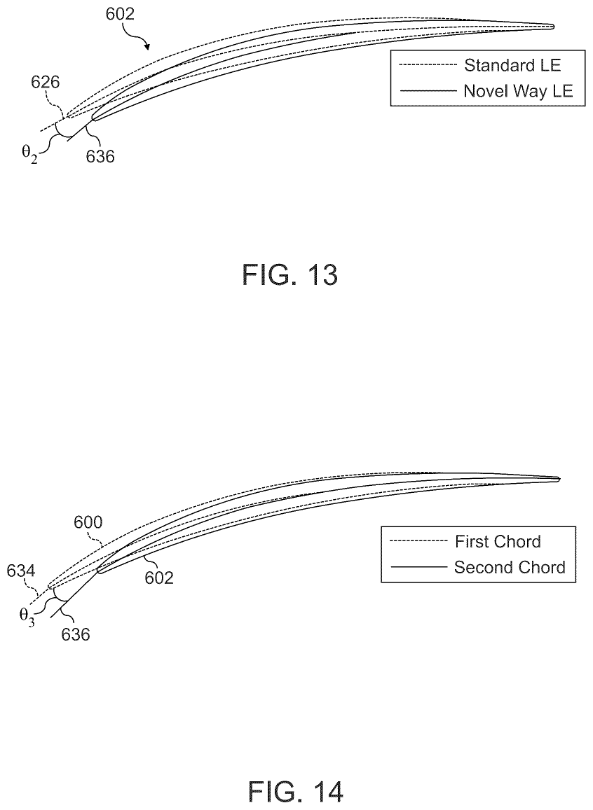

In at least one example embodiment, a distance 642 is measured between the second contoured sidewall 582 of the wave tip 608 and the second contoured sidewall 582 of the wave trough 610. Moreover, in an example embodiment, a distance 642 defined on the leading edge 584 can be further increased by increasing the angular distance 03 at the leading edge 584 between the first chord camber line 634 and the second chord camber line 636 as detailed in FIG. 14. As described in more detail below, increasing the distance 642 facilitates reduction of the unsteady air pressures caused by wakes impinging upon the leading edge 584 of the airfoil 570. More specifically, increasing the distance 642 may facilitate decorrelation of the unsteady pressures and reduction of the amplitude of the airfoil unsteady pressure response to impinging wakes and vortices upon the airfoil 570, which facilitates noise and aeromechanical loading reduction. In at least one example embodiment, changing the second chord thickness 630 may facilitate controlling or mitigating the leading edge suction peak. A well designed leading edge 584 may mitigate a leading edge suction peak and concomitant noise penalty at the second chord sections 602, improving overall wavy leading edge effectiveness. The airfoil 570 is thus configured to facilitate desensitization of the airfoil unsteady pressure response to at least one impinging unsteady wake by decorrelating (spatially and temporally) and reducing in amplitude the unsteady pressure caused by interaction with the upstream generated wake or vortex and minimizing high flow acceleration around the leading edge 584. In addition, the inclusion of the wavy leading edge features enables a change in time-averaged and unsteady surface pressure fields, thereby reducing generated noise.

During engine operation, a plurality of fan blades, such as the rotor fan blades 540 shown in FIG. 7 rotate about the axis 512 (FIG. 7) such that the airflow 560 impinges on the leading edges 584 of the airfoils 570 of an outlet guide vane assembly. More specifically, the airflow 560 impinges upon the waves 606 and camber waves 632 and is channeled over each airfoil 570 in a downstream direction. As the airflow 560 impinges upon the waves 606 and the camber waves 632, decorrelation of the airfoil unsteady pressure response to impinging non-uniform airflow 560 is achieved. More specifically, decorrelation of the unsteady gust interaction with the airfoil may lead to reduction in the amplitude of the resulting unsteady surface pressures, thereby reducing the noise levels radiated by the airfoil 570.

As the airflow 560 impinges upon the leading edge 584 of the airfoil 570, decorrelation of the airfoil unsteady pressure response takes place in a number of ways: (i) the arrival time of the vorticity in the incident airflow 560 is modified by the physical location of the interacting leading edge 584; (ii) the airfoil surface unsteady pressure at the leading edge 584 is spatially less coherent (than a conventional leading edge), thus the surface pressure of the airfoil 570 responds differently than for a conventional leading edge with adverse effects of the leading edge suction peak at sections 602 being minimized; and (iii) the airfoil 570 mean loading is altered by the wavy leading edge 584 such that the unsteady response about the modified mean loading is less coherent. Note that even if wavy variations in the arrival time of the incident vorticity at the leading edge were somehow (artificially) removed, the wavy leading edge may still respond with a lower unsteady pressure relative to a conventional leading edge due to the curved leading edge and wavy airfoil surface itself.

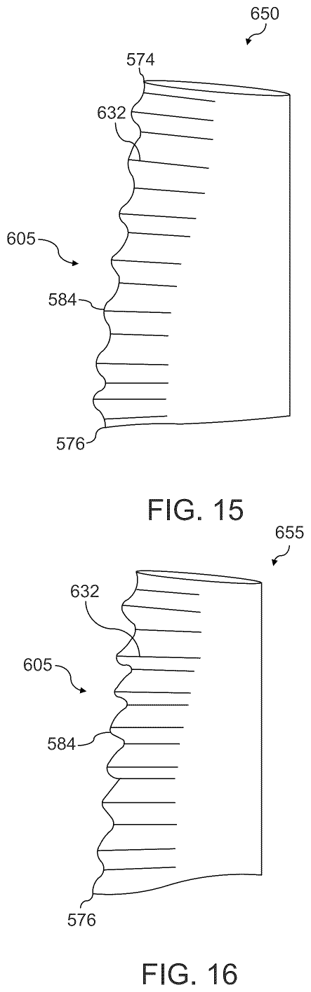

Now referring to FIGS. 15 and 16, schematic plan views of various airfoil configurations according to embodiments disclosed herein are illustrates. More particularly, FIG. 15 illustrates a schematic plan view of an airfoil 650, generally similar to previously described airfoil 570 of FIGS. 9-14. In the illustrated embodiment, the airfoil 650 includes a waveform 605 on a leading edge 584 and plurality of camber waves 632, both formed along substantially an entire length of the airfoil 570 in a span-wise direction. More specifically, the waveform 605 and camber waves 632 create a three-dimensional airfoil extending from the tip portion 574 to the root portion 576. In this illustrated embodiment, the plurality of waves 606 that comprise the waveform 605 and camber waves 632 are formed substantially evenly along substantially the entire length of the airfoil in the span-wise direction. As previously described, the waves 606 are substantially equal, such that the partial spanwise wavelength 604 of the radial inner edge 614 (FIG. 10), is substantially equal to the partial spanwise wavelength 618 of the radial outer edge 612 (FIG. 10). In other example embodiments, such as illustrated in FIG. 16, the waves 606 may include substantially unevenly spaced wave configurations. In still other example embodiments, the waveform may be applied to the entire leading edge, resulting in larger noise and aeromechanical loading benefits.

FIG. 16 illustrates a schematic plan view of an alternate airfoil 655, generally similar to previously described airfoil 570 of FIGS. 9-14. In the embodiment shown, airfoil 655 includes a waveform 605 on a leading edge 584 and a plurality of camber waves 632, both formed along a substantial portion of the length of the airfoil 570 in a span-wise direction. More specifically, the waveform 605 and camber waves 632 create a three-dimensional airfoil extending from the tip portion 574 to the root portion 576 in the span-wise direction. In this illustrated embodiment, the plurality of waves 606 that comprise the waveform 605 and camber waves 632 are formed substantially unevenly along substantially the entire length of the airfoil 570 in the span-wise direction. More specifically, as previously described, the partial spanwise wavelength 604 of the radial inner edge 614 (FIG. 10) is not substantially equal to the partial spanwise wavelength 618 of the radial outer edge 612 (FIG. 10). Using an asymmetric waveform can improve the decorrelation of unsteady pressure response generated by the airfoil to impinging wakes and vortices from upstream. In an alternate embodiment, the plurality of waves 606 may be formed substantially unevenly along only a portion of the length of the airfoil 570 in the span-wise direction such as formed at a central portion or a distal, or tip end of the airfoil 570.

FIG. 17 illustrates a perspective view of one embodiment of aerodynamic surface embodying the wavy leading edge as disclosed herein. More particularly, a fan blade 700 is illustrated, generally similar to the rotor fan blade 540 of FIG. 7 that may be used in an engine assembly, and generally similar to the gas turbine engine 510 of FIG. 7. In at least one example embodiment, the fan blade 700 includes an airfoil 702, a platform 703 and a root portion 706. Additionally, or alternatively, the airfoil 702 may be used with, but not limited to, rotor blades, stator blades, and/or nozzle assemblies. In an embodiment, the root portion 706 includes an integral dovetail 708 that enables the airfoil 702 to be mounted to the rotor disk, such as the fan rotor disk 542 of FIG. 7. The airfoil 702 includes a first contoured sidewall 710 and a second contoured sidewall 712. Specifically, in an example embodiment, the first contoured sidewall 710 defines a pressure side 711 of the airfoil 702, and the second contoured sidewall 712 defines a suction side 713 of the airfoil 702. The sidewalls 710 and 712 are coupled together at a leading edge 714 and at a trailing edge 716. The trailing edge 716 is spaced chord-wise and downstream from the leading edge 714. The pressure side 711 and the suction side 713, and more particularly first contoured sidewall 710 and second contoured sidewall 712, respectively, each extend outward spanwise, from the root portion 706 to a tip portion 704. Alternatively, the airfoil 702 may have any conventional form, with or without the dovetail 708 or platform 703. For example, the airfoil 570 may be formed integrally with a rotor disk in a blisk-type configuration that does not include the dovetail 708 and the platform 703.

In at least one example embodiment, and as explained in detail with regard to the first embodiment, the airfoil 702 includes a plurality of first chord sections 730 and a plurality of second chord sections 732, of which only a representative sample are shown. The first chord sections 730 and the second chord sections 732 extend generally chord-wise between the leading edge 714 and the trailing edge 716. Similar to the airfoil 570, as previously described in detail in FIGS. 9-11, each first chord section 730 is radially-spaced a distance away from an immediately adjacent second chord section 732. In an embodiment, the at least one first chord section 730 may be formed with a chord length 724 that is substantially equal to a chord length 726 of at least one second chord section 732, and including at least one of a camber, thickness, or airfoil stacking wave (e.g., dihedral). In an alternate embodiment, the at least one first chord section 730 may be formed with a chord length 724 that is longer than a chord length 726 of at least one second chord section 732 thereby defining a waveform, generally similar to waveform 605 of FIG. 9, defined by plurality of waves along the leading edge 584. In an embodiment, each first chord section 730 defines a wave tip 738 along the leading edge 714. Similarly, each second chord section 732 defines a wave trough 740 along the leading edge 714. As a result, in an example embodiment, the plurality of alternating first chord sections 730 and second chord sections 732, define the waves 736, and thus the wave-like pattern or waveform 735 extending along the leading edge 714.

As set forth above with respect to FIG. 10, the waves 736 each include a radially inner edge 744 and a radially outer edge 742. Moreover, the leading edge 714 is defined by the plurality of wave tips 738 and by the plurality of wave troughs 740. More specifically, each wave tip 738 is defined on a respective first chord section 730. Similarly, each wave trough 740 is defined on a respective second chord section 732. As a result, in an embodiment, each wave tip 738 extends, in a chord-wise direction, a distance upstream from each wave trough 740. Moreover, in an embodiment, each radially inner edge 744 and radially outer edge 742 extends generally radially between a wave tip 738 and a wave trough 740.

In at least one example embodiment, the number of alternating adjacent first chord sections 730 and second chord sections 732 determines the number of waves 736 defined along the leading edge 714. Specifically, in an example embodiment, each second chord section 732 may be separated by a distance 733 from each first chord section 730, measured with respect to the radially inner edge 744. Similarly, in an embodiment, each first chord section 730 is separated by a distance 731 from each second chord section 732 measured with respect to the radially outer edge 742. The distances may be substantially zero such that the radially inner and outer edges 742 and 744, respectively, extend substantially chord-wise between the wave tip 738 and the wave trough 740. As previously detailed with respect to FIGS. 9-11, the waves 736 may be formed substantially equal, unequal, or include both equal and unequal waves. In another embodiment, the radially inner edge 744 and the radially outer edge 742 may have any plan shape that extends between the wave tip 738 and the wave trough 740 including, but not limited to a sinusoidal edge. The waves 736 may be designed to maintain an appropriate local average chord, camber and stacking (e.g., dihedral) such that the aerodynamic performance of the airfoil 702 is not penalized.

In the illustrated embodiment, the wave trough portion 740 has a length that extends generally along the leading edge 714. Similarly, in an embodiment, the wave tip portion 738 has a length that extends generally along the leading edge 714. The length of the wave trough portion 740 may be substantially zero such that the wave trough portion 740 is substantially a transition point defined between the radially inner edge 744 and the radially outer edge 742. In another embodiment, the length may be substantially zero such that the wave tip portion 738 is substantially a transition point defined between the radially inner edge 744 and the radially outer edge 742. The plurality of waves 736 are each fabricated with a pre-determined aspect ratio as previously described with regard to the airfoil 570 (FIGS. 8-16).

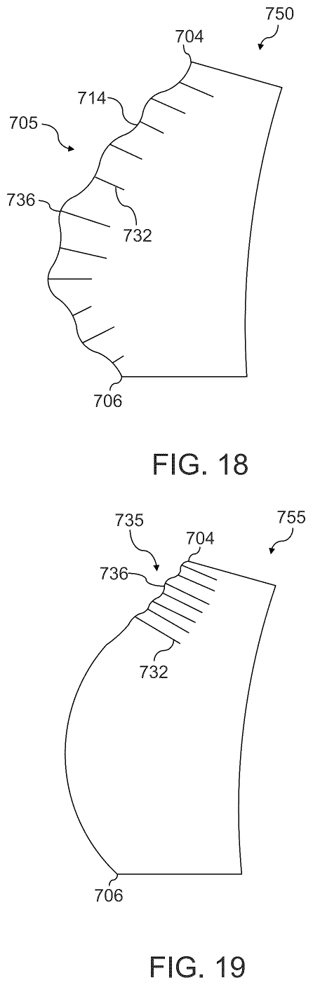

With reference to FIGS. 18-21, schematic plan views of various airfoil configurations according to embodiments disclosed herein are illustrated. More particularly, FIG. 18 is a schematic plan view of an airfoil 750. In the illustrated embodiment, airfoil 750 includes a plurality of waves 736 that comprise a waveform 735 on a leading edge 714 and a plurality of camber waves 736, both formed along substantially an entire length of the airfoil 750 in a span-wise direction. More specifically, the waveform 735 and camber waves 736 create a three-dimensional airfoil extending from the root portion 706 to the tip portion 704. In this illustrated embodiment, the plurality of waves 736 and the camber waves 736 are formed substantially equally along substantially the entire length of the airfoil in the span-wise direction. As previously described, the waves 736 are substantially equal, such that the partial spanwise wavelength of the radially inner edge 744 (FIG. 17), is substantially equal to the partial spanwise wavelength of the radially outer edge 742 (FIG. 17). An alternate embodiment may include unequal wave configurations as previously described spaced along substantially the entire length of the airfoil in the span-wise direction. In yet another alternate embodiment, the airfoil 750 may be configured having substantially equal chord sections lengths (not shown), as previously described, and including at least one of a camber, thickness, or stacking wave, thereby defining an airfoil with only a plurality of camber waves 736.

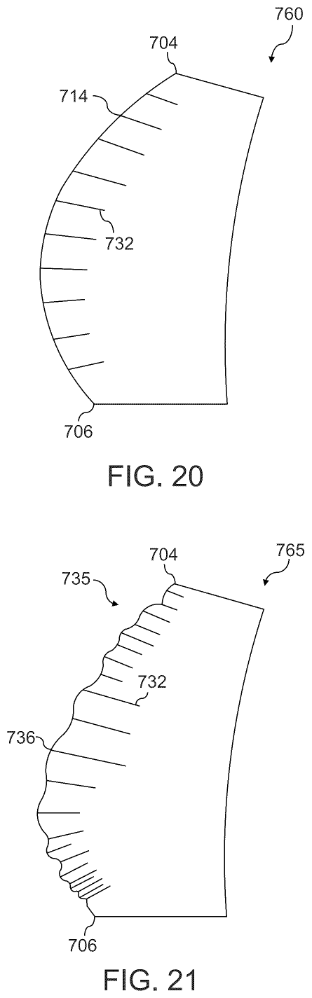

FIG. 19 illustrates a schematic plan view of an alternate airfoil 755. In the illustrated embodiment, airfoil 755 includes a waveform 735 on a leading edge 714 and a plurality of camber waves 736, both formed along only a portion of the length of the airfoil 755 in a span-wise direction. In the illustrated embodiment, the waveform 735 and camber waves 736 are formed at a distal, or tip, end of the airfoil 755 near tip portion 704. More specifically, the waveform 735 and camber waves 736 create a three-dimensional airfoil extending from the tip portion 704 to a point along the leading edge 714 that is only a portion of the entire length of the airfoil 755 in the span-wise direction. In this illustrated embodiment, the plurality of waves 736 and camber waves 736 are equal in configuration. In an alternate embodiment, the plurality of waves 736 may be formed unequal in configuration and along only a portion of the length of the airfoil 755 in the span-wise direction. In yet another embodiment, as best illustrated in FIG. 20, an airfoil 760 may be configured having substantially equal chord sections lengths, as previously described, thereby defining an airfoil with only a plurality of camber waves 736 formed along only a portion of the entire length of the airfoil 760.

With reference to FIG. 21, a schematic plan view of yet another alternate airfoil 765 is illustrated. In the illustrated embodiment, airfoil 765 includes a waveform 735 on a leading edge 714 and plurality of camber waves 736 formed along substantially the entire length of the airfoil 765 in a span-wise direction. The waveform 735 and camber waves 736 create a three-dimensional airfoil extending substantially the entire length of the airfoil 765 from the root portion 706 to the tip portion 704. In this illustrated embodiment, the plurality of waves 736 that comprise the waveform 735 and camber waves 736 are configured either equal and/or unequal, but with varying radially inner and outer edges along the length of the airfoil in the span-wise direction. More specifically, as previously described, the partial spanwise wavelengths of the radially inner edge 744 (FIG. 17) and the radially outer edge 742 (FIG. 17) are not substantially equal, nor are they equivalent. In the embodiments described herein, each airfoil configuration is designed to facilitate desensitization of the airfoil unsteady pressure response to incoming fluid gusts, as well as unsteady pressure waves (acoustic waves) impinging on the leading edge by decorrelating in time and space and reducing in amplitude the airfoil response to the plurality of wakes, vortices and waves that impinge on the leading edge of the airfoil from an upstream component, such as an upstream rotary component, stator component, or an upstream unsteady fluid inflow impinging thereupon.

Described herein is also a method of fabricating an airfoil. The method includes fabricating at least one airfoil including a first contoured sidewall, or pressure side and a second contoured sidewall, or suction side coupled together at a leading edge and a trailing edge, wherein the airfoil includes a plurality of first and second chord sections each extending between the leading and trailing edges. At least one of the first chord sections extends outward from one of the first contoured sidewall or the second contoured sidewall of the airfoil at the leading edge, and at least one of the second chord sections extends outward from one of the first contoured sidewall or the second contoured sidewall of the airfoil at the leading edge. The plurality of first chord sections defining at least one first chord length. The plurality of second chord sections defining at least one second chord length, each extending between the trailing and leading edges, wherein said first chord length may be longer than the second chord length. The airfoil further includes a plurality of first chord sections having a first chord thickness, and a plurality of second chord sections having a second chord thickness.

The above-described three-dimensional wavy leading edge airfoils effectively desensitize the blade response to an impinging fluid gust or wake and facilitate reducing the noise and aeromechanical loading generated during engine operation. During engine operation, the airfoils may be subject to impinging wakes and vortices from an upstream object or unsteady inlet flow that generate noise and aeromechanical loading when the wake impinges on the airfoil. In an embodiment, each airfoil includes a leading edge that includes a plurality of wave-shaped projections, or waves. Moreover, in such an embodiment, the plurality of waves define a plurality of tips and troughs along the leading edge and a plurality of camber waves on the airfoil, resulting in a three-dimensional crenulated airfoil. The airfoil leading edge waves and camber waves facilitate desensitizing of the airfoil by decorrelating and reducing the amplitude of the airfoil unsteady response to impinging wakes and vortices. More specifically, the airfoil leading edge waves and camber waves facilitate both decorrelation and amplitude reduction of unsteady pressures generated by the wakes impinging on the airfoil by modifying the arrival time of the vorticity in the impinging airflow, modifying the airfoil unsteady pressure loading at the leading edge to be spatially less coherent than a conventional leading edge and minimizing the adverse effect of the leading edge suction peak and improving the unsteady pressure response of the airfoil, and altering the time-averaged loading of the airfoil such that the unsteady response about the modified time-averaged loading is reduced and less coherent.

The leading edge configured in this manner addresses the unsteady aerodynamic and aeroacoustic response of a blade, vane, or general aerodynamic surface to a relative unsteady incoming flow disturbance. More specifically, the leading edge configured as described herein facilitates reducing the magnitude of the airfoil unsteady pressure response to wakes and vortices impinging on the leading edge of the airfoil such that the noise and aeromechanical loading are facilitated to be reduced. The decorrelation and reduction in amplitude of the unsteady pressure response to impinging wakes may facilitate reducing the axial distance necessary between the airfoils and upstream components. As a result, engine efficiency and performance are facilitated to be improved in comparison to engines using standard airfoils without a plurality of waves and camber waves defined on at least a portion of a leading edge of at least one airfoil. In addition, the reduction in radiated noise and aeromechanical loading are achieved without an increase in blade or vane weight, without substantially decreasing aerodynamic performance, and without any otherwise impact on the overall engine system (length, weight, structure, etc.). In an embodiment, the wavy leading edge design disclosed herein may allow for a change in engine design that would normally increase noise if a conventional airfoil leading edge were used (e.g., reduced fan-OGV axial spacing, reduced fan diameter, increased fan tip speed, reduced OGV sweep, etc.) but allow for maintenance of target noise levels while gaining overall system performance.

Exemplary embodiments of airfoils including fan blades and guide vanes are described above in detail. The airfoils are not limited to the specific embodiments described herein, but rather, may be applied to any type of airfoil that are subjected to impinging wakes and vortices from an upstream object, such as a fan blade, stator, airframe, or an unsteady fluid flow. The airfoils described herein may be used in combination with other blade system components with other engines.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A turbomachine for an aircraft, comprising: an annular casing; and a fan disposed inside the annular casing and mounted for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip Mach number (“M_{tip,c}^{(RL)}”), according to a First Performance Factor; wherein

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 ,$$

and wherein m₁·[M_{tip,c}^{(RL)}−1.1]+6>FPF>m₁·[M_{tip,c}^{(RL)}−1.1]+Δy₁, and wherein 0<Δy₁<6.

The turbomachine of one or more of these clauses wherein M_{tip,c}^{(RL)} is within a range equal to or greater than 0.45 and equal to or less than 1.34.

The turbomachine of one or more of these clauses wherein M_{tip,c}^{(RL)} within a range equal to or greater than 0.45 and equal to or less than 1.12.

The turbomachine of one or more of these clauses wherein m₁ is equal to 0.87 when M_{tip,c}^{(RL)} is greater than or equal to 1.1.

The turbomachine of one or more of these clauses wherein m₁ is equal to 1.0 when M_{tip,c}^{(RL)} is greater than or equal to 1.1.

The turbomachine of one or more of these clauses wherein m₁ is equal to 2.5 when M_{tip,c}^{(RL)} is less than 1.1.

The turbomachine of one or more of these clauses wherein m₁ is equal to 3.34 when M_{tip,c}^{(RL)} is less than 1.1.

The turbomachine of one or more of these clauses wherein Δy₁ is equal to or greater than 0.0125 and less than 6.

The turbomachine of one or more of these clauses wherein Δy₁ is equal to or greater than 0.04 and less than 6.

The turbomachine of one or more of these clauses wherein Δy1 is equal to or greater than 0.07 and less than 6.

The turbomachine of one or more of these clauses wherein Δy1 is equal to or greater than 0.1 and less than 6.

The turbomachine of one or more of these clauses wherein Δy1 is equal to or greater than 0.2 and less than 6.

The turbomachine of one or more of these clauses wherein the turbomachine has a gear ratio within a range equal to or greater than 3.2 and equal to or less than 5.0.

The turbomachine of one or more of these clauses wherein the fan blade includes an airfoil portion made from a polymer matrix composite (PMC) material, a metallic leading edge, the ratio c/D is between 0.16 and 0.21, and the fan has between 16 and 25 fan blades.

The turbomachine of one or more of these clauses wherein ratio c/D is within a range equal to or greater than 0.1 and equal to or less than 0.3.

The turbomachine of one or more of these clauses wherein ratio c/D is within a range equal to or greater than 0.15 and equal to or less than 0.21.

The turbomachine of one or more of these clauses wherein ratio c/D is equal to or greater than 0.1.

The turbomachine of one or more of these clauses wherein ratio c/D is equal to or less than 0.3.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

The turbomachine of one or more of these clauses wherein FPR is equal to or greater than 1.2.

The turbomachine of one or more of these clauses wherein FPR is equal to or greater than 1.3.

The turbomachine of one or more of these clauses wherein FPR is equal to or less than 1.5.

The turbomachine of one or more of these clauses wherein FPR is equal to or less than 1.45.

The turbomachine of one or more of these clauses wherein U_{c(tip)} is within a range equal to or greater than 500 ft/sec and equal to or less than 1,500 ft/sec.

The turbomachine of one or more of these clauses wherein U_{c(tip)} is within a range equal to or greater than 500 ft/sec and equal to or less than 1,250 ft/sec.

A turbomachine comprising: an annular casing; and a fan disposed inside the annular casing and mounted for rotation about an axial centerline, the fan including fan blades that extend radially outwardly toward the annular casing; wherein the fan includes a fan hub-to-tip ratio (“HTR”), a fan blade count (“BC”), a fan pressure ratio (“FPR”), and a redline corrected redline fan tip Mach number (“M_{tip,c}^{(RL)}”) according to a Second Performance Factor (“SPF”),

$$SPF = \sqrt{\frac{π}{4} ( 1 - {HTR}^{2} ) / ( \frac{BC}{20} )} / ( \frac{\sqrt{FPR - 1}}{\sqrt{0.4}} ) / {M}_{tip , c}^{( RL )} - 0.97 ,$$

wherein m₂·[M_{tip,c}^{(RL)}−1.1]+1.5>SPF>m₂·[M_{tip,c}^{(RL)}−1.1]+Δy₂, and wherein 0<Δy₂<1.5.

The turbomachine of one or more of these clauses wherein Δy₂ is equal to or greater than 0.0075 and less than 1.5.

The turbomachine of one or more of these clauses wherein Δy₂ is equal to or greater than 0.01 and less than 1.5.

The turbomachine of one or more of these clauses wherein Δy₂ is equal to or greater than 0.02 and less than 1.5.

The turbomachine of one or more of these clauses wherein Δy₂ is equal to or greater than 0.024 and less than 1.5.

The turbomachine of one or more of these clauses wherein Δy₂ is equal to or greater than 0.037 and less than 1.5.

The turbomachine of one or more of these clauses wherein Δy₂ is equal to or greater than 0.04 and less than 1.5.

The turbomachine of one or more of these clauses wherein Δy₂ is equal to or greater than 0.06 and less than 1.5.

The turbomachine of one or more of these clauses wherein m₂ is equal to 0.41 when M_{tip,c}^{(RL)} is greater than or equal to 1.1.

The turbomachine of one or more of these clauses wherein m₂ is equal to 0.55 when M_{tip,c}^{(RL)} is less than 1.1.

The turbomachine of one or more of these clauses wherein HTR is within a range equal to or greater than 0.1 and equal to or less than 0.5.

The turbomachine of one or more of these clauses wherein HTR is within a range equal to or greater than 0.2 and equal to or less than 0.275.

The turbomachine of one or more of these clauses wherein HTR is within a range equal to or greater than 0.2 and equal to or less than 0.25.

The turbomachine of one or more of these clauses wherein HTR is equal to or greater than 0.1.

The turbomachine of one or more of these clauses wherein HTR is equal to or less than 0.5.

The turbomachine of one or more of these clauses wherein BC is within a range equal to or greater than 10 and equal to or less than 18.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

A method of assembly, comprising: mounting a fan inside an annular casing for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip redline Mach number (“M_{tip,c}^{(RL)}”) according to a First Performance Factor (“FPF”), wherein:

$$FPF = [ \frac{c}{0.15 \cdot D} ] / [ [ \frac{\sqrt{FPR - 1}}{\sqrt{0.4}} ] / {M}_{tip , c}^{( RL )} ] - 1.23 ; \\ {m}_{1} \cdot [ {M}_{tip , c}^{( RL )} - 1.1 ] + 6 > FPF > {m}_{1} \cdot [ {M}_{tip , c}^{( RL )} - 1.1 ] + Δ {y}_{1} ;$$

and 0<Δy₁<6; or wherein the fan includes a fan hub-to-tip ratio (“HTR”), a fan blade count (“BC”), FPR, and M_{tip,c}^{(RL)} according to a Second Performance Factor (“SPF”), wherein

$$SPF = \sqrt{\frac{π}{4} ( 1 - H T {R}^{2} ) / ( \frac{B C}{20} )} / ( \frac{\sqrt{F P R - 1}}{\sqrt{0.4}} ) / {M}_{t ip , c}^{( R L )} - 0.97 ;$$

$${m}_{2} \cdot [ {M}_{t ip , c}^{( R L )} - 1.1 ] + 1.5 > SPF > {m}_{2} \cdot [ {M}_{t ip , c}^{( R L )} - 1.1 ] + Δ {y}_{2} ;$$

and 0<Δ₂<1.5.

A turbomachine for an aircraft, comprising: an annular casing; and a fan disposed inside the annular casing and mounted for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip Mach number (“M_{tip,c}^{(RL)}”), according to a First Performance Factor; wherein

$$FPF = [ \frac{c}{0.15 \cdot D} ] / [ [ \frac{\sqrt{F P R - 1}}{\sqrt{0.4}} ] / {M}_{t ip , c}^{( R L )} ] - 1.23 ,$$

and wherein m₁·[M_{tip,c}^{(RL)}−1.1]+9.14>FPF>m₂·[M_{tip,c}^{(RL)}−1.1], wherein m₁ is equal to 9.43 when M_{tip,c}^{(RL)} is greater than or equal to 1.1 and is equal to 27.02 when M_{tip,c}^{(RL)} is less than 1.1, and wherein m₂ is equal to 0.87 when M_{tip,c}^{(RL)} is greater than or equal to 1.1 and is equal to 3.34 when M_{tip,c}^{(RL)} is less than 1.1.

The turbomachine of one or more of these clauses wherein FPF is within a range equal to or greater than −0.8 and equal to or less than 8.4.

The turbomachine of one or more of these clauses wherein FPF is within a range equal to or greater than 0 and equal to or less than 6.

The turbomachine of one or more of these clauses wherein FPF is within a range equal to or greater than 1 and equal to or less than 2.

The turbomachine of one or more of these clauses wherein M_{tip,c}^{(RL)} is within a range equal to or greater than 0.8 and equal to or less than 1.5.

The turbomachine of one or more of these clauses wherein M_{tip,c}^{(RL)} is within a range equal to or greater than 0.9 and equal to or less than 1.4.

The turbomachine of one or more of these clauses wherein ratio c/D is within a range equal to or greater than 0.1 and equal to or less than 0.3.

The turbomachine of one or more of these clauses wherein FPR is within a range equal to or greater than 1.2 and equal to or less than 1.6.

The turbomachine of one or more of these clauses wherein FPR is within a range equal to or greater than 1.3 and equal to or less than 1.5.

The turbomachine of one or more of these clauses wherein FPR is within a range equal to or greater than 1.35 and equal to or less than 1.45.

The turbomachine of one or more of these clauses wherein the turbomachine has a gear ratio within a range equal to or greater than 3.2 and equal to or less than 5.0.

The turbomachine of one or more of these clauses wherein the fan blade includes an airfoil portion made from a polymer matrix composite (PMC) material, a metallic leading edge, the ratio c/D is between 0.16 and 0.21, and the fan has between 16 and 25 fan blades.

A turbomachine comprising: an annular casing; and a fan disposed inside the annular casing and mounted for rotation about an axial centerline, the fan including fan blades that extend radially outwardly toward the annular casing; wherein the fan includes a fan hub-to-tip ratio (“HTR”), a fan blade count (“BC”), a fan pressure ratio (“FPR”), and a redline corrected redline fan tip Mach number (“M_{tip,c}^{(RL)}”) according to a Second Performance Factor (“SPF”),

$$SPF = SPF = \sqrt{\frac{π}{4} ( 1 - H T {R}^{2} ) / ( \frac{B C}{20} )} / ( \frac{\sqrt{F P R - 1}}{\sqrt{0.4}} ) / {M}_{t ip , c}^{( R L )} - 0.97 ,$$

wherein m₃·[M_{tip,c}^{(RL)}−1.1]+2.52>SPF>m₄·[M_{tip,c}^{(RL)}−1.1] wherein m₃ is equal to 3.17, and wherein m₄ is equal to 0.41 when M_{tip,c}^{(RL)} is greater than or equal to 1.1 and is equal to 0.55 when M_{tip,c}^{(RL)} is less than 1.1.

The turbomachine of one or more of these clauses wherein SPF is within a range equal to or greater than 0.087 and equal to or less than 2.4.

The turbomachine of one or more of these clauses wherein SPF is within a range equal to or greater than 1 and equal to or less than 2.

A turbomachine for an aircraft, comprising: an annular casing; and a fan disposed inside the annular casing and mounted for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip speed (“U_{c(tip)}”), according to a First Performance Factor; wherein

$$FPF = [ c / D ] / [ \sqrt{F P R - 1} / {U}_{c ( t i p )} ] ;$$

and wherein 0.24*U_{c(tip)}+489>FPF>0.24*U_{c(tip)}−12+dy₁ and wherein 0<dy₁<500.

The turbomachine of one or more of these clauses wherein ratio c/D is within a range equal to or greater than 0.1 and equal to or less than 0.3.

The turbomachine of one or more of these clauses wherein ratio c/D is within a range equal to or greater than 0.15 and equal to or less than 0.21.

The turbomachine of one or more of these clauses wherein ratio c/D is equal to or greater than 0.1.

The turbomachine of one or more of these clauses wherein ratio c/D is equal to or less than 0.3.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

The turbomachine of one or more of these clauses wherein FPR is equal to or greater than 1.2.

The turbomachine of one or more of these clauses wherein FPR is equal to or greater than 1.3.

The turbomachine of one or more of these clauses wherein FPR is equal to or less than 1.5.

The turbomachine of one or more of these clauses wherein FPR is equal to or less than 1.45.

The turbomachine of one or more of these clauses wherein U_{c(tip)} is within a range equal to or greater than 500 ft/sec and equal to or less than 1,500 ft/sec.

The turbomachine of one or more of these clauses wherein U_{c(tip)} is within a range equal to or greater than 500 ft/sec and equal to or less than 1,250 ft/sec.

The turbomachine of one or more of these clauses wherein dy₁ is equal to or greater than 7.5 and equal to or less than 500.

The turbomachine of one or more of these clauses wherein dy₁ is equal to or greater than 16 and equal to or less than 500.

The turbomachine of one or more of these clauses wherein dy₁ is equal to or greater than 25 and equal to or less than 500.

A turbomachine comprising: an annular casing; and a fan disposed inside the annular casing and mounted for rotation about an axial centerline, the fan including fan blades that extend radially outwardly toward the annular casing; wherein the fan includes a fan hub-to-tip ratio (“HTR”), a fan blade count (“BC”), a fan pressure ratio (“FPR”), and a redline corrected fan tip speed (“U_{c(tip)}”) according to a Second Performance Factor (“SPF”); wherein

$$SPF = \sqrt{\frac{π}{4} \cdot ( \frac{1 - H T {R}^{2}}{B C} )} / [ \frac{\sqrt{F P R - 1}}{{U}_{c ( t i p )}} ] ;$$

and wherein 0.15* U_{c(tip)}+654>SPF>0.15*U_{c(tip)}+153+dy₂ and wherein 0<dy₂<500.

The turbomachine of one or more of these clauses wherein HTR is within a range equal to or greater than 0.1 and equal to or less than 0.5.

The turbomachine of one or more of these clauses wherein HTR is within a range equal to or greater than 0.2 and equal to or less than 0.275.

The turbomachine of one or more of these clauses wherein HTR is within a range equal to or greater than 0.2 and equal to or less than 0.25.

The turbomachine of one or more of these clauses wherein HTR is equal to or greater than 0.1.

The turbomachine of one or more of these clauses wherein HTR is equal to or less than 0.5.

The turbomachine of one or more of these clauses wherein BC is within a range equal to or greater than 10 and equal to or less than 18.

The turbomachine of one or more of these clauses wherein FPR is within a range equal to or greater than 1.2 and equal to or less than 1.5.

The turbomachine of one or more of these clauses wherein FPR is within a range equal to or greater than 1.3 and equal to or less than 1.45.

The turbomachine of one or more of these clauses wherein FPR is equal to or greater than 1.2.

The turbomachine of one or more of these clauses wherein FPR is equal to or greater than 1.3.

The turbomachine of one or more of these clauses wherein FPR is equal to or less than 1.5.

The turbomachine of one or more of these clauses wherein FPR is equal to or less than 1.45.

The turbomachine of one or more of these clauses wherein U_{c(tip)} is within a range equal to or greater than 500 ft/sec and equal to or less than 1,500 ft/sec.

The turbomachine of one or more of these clauses wherein U_{c(tip)} is within a range equal to or greater than 500 ft/sec and equal to or less than 1,250 ft/sec.

The turbomachine of one or more of these clauses wherein dy₂ is equal to 5 and equal to or less than 500.

The turbomachine of one or more of these clauses wherein dy₂ is equal to 10 and equal to or less than 500.

The turbomachine of one or more of these clauses wherein dy₂ is equal to 15 and equal to or less than 500.

A method of assembly, comprising: mounting a fan inside an annular casing for rotation about an axial centerline, the fan including fan blades that extend radially outwardly toward the annular casing; wherein the fan includes an average fan chord width of the fan blades (“c”), a diameter of the fan (“D”), a fan pressure ratio (“FPR”), and a redline corrected fan tip speed (“U_{c(tip)}”) according to a First Performance Factor (“FPF”), wherein

$$FPF = [ c / D ] / [ \sqrt{F P R - 1} / {U}_{c ( t i p )} ] ;$$

and 0.24*U_{c(tip)}+489>FPF>0.24*U_{c(tip)}−12+dy₁ and wherein 0<dy₁<500; or wherein the fan includes a fan hub-to-tip ratio (“HTR”), a fan blade count (“BC”), FPR, and U_{c(tip)} according to a Second Performance Factor (“SPF”), wherein

$$SPF = \sqrt{\frac{π}{4} \cdot ( \frac{1 - H T {R}^{2}}{B C} )} / [ \frac{\sqrt{F P R - 1}}{{U}_{c ( t i p )}} ] ;$$

and 0.15*U_{c(tip)}+654>SPF>0.15*U_{c(tip)}+153+dy₂ and wherein 0<dy₂<500.

An airfoil comprising: a first side and a second side coupled together at a leading edge and a trailing edge; a plurality of first chord sections defining at least one first chord length and a plurality of second chord sections defining at least one second chord length, the plurality of first chord sections and second chord sections defining a waveform along a leading edge of the airfoil, said leading edge comprises: a plurality of spaced-apart wave-shaped projections each wave-shaped projection of said plurality of wave-shaped projections defines a wave tip and at least one trough portion defined between at least one pair of adjacent spaced-apart wave-shaped projections, wherein adjacent wave-shaped projections define a tip-to-tip distance therebetween, the tip-to-tip distance is within a range of values representative of a percentage of the at least one first chord length, wherein said wave-shaped projections are at least one of substantially evenly spaced and unevenly spaced, and wherein at least one chord section of said plurality of first chord sections extends outward from one of the first side or the second side of the airfoil at the leading edge, and at least one chord section of said plurality of second chord sections extends outward from one of the first side or the second side of the airfoil at the leading edge, the outwardly extending first and second chord sections and the plurality of spaced-apart wave-shaped projections defining a three-dimensional crenulated airfoil, and wherein the at least one airfoil is configured to facilitate desensitization of an airfoil unsteady pressure response to at least one impinging upstream generated wake or vortex by decorrelating spatially and temporally and reducing in amplitude an unsteady pressure caused by interaction of the airfoil with the upstream generated wake or vortex.

An airfoil of one or more of these clauses, wherein said airfoil is configured to minimize adverse effects of a high flow acceleration around the leading edge.

An airfoil of one or more of these clauses, further comprising a thickness measured between said first and second sides extending from said leading edge to said trailing edge, said airfoil thickness varies in a span-wise direction.

An airfoil of one or more of these clauses, wherein said plurality of first chord sections has a first thickness and said plurality of second chord sections has a second thickness, each first chord section of said plurality of first chord sections is defined between each second chord section of said plurality of second chord sections.

An airfoil of one or more of these clauses, wherein the first chord length is longer than the second chord length.

An airfoil of one or more of these clauses, wherein the plurality of spaced-apart wave-shaped projections are formed along only a portion of the airfoil in a span-wise direction.

An airfoil of one or more of these clauses, wherein the plurality of spaced-apart wave-shaped projections are formed along substantially an entire length of the airfoil in a span-wise direction.

An airfoil of one or more of these clauses, wherein the plurality of spaced-apart wave-shaped projections are unequal.

An airfoil of one or more of these clauses, wherein the plurality of spaced-apart wave-shaped projections are equal.

An airfoil of one or more of these clauses, wherein a portion of the plurality of spaced-apart wave-shaped projections are equal and a portion of the spaced-apart wave-shaped projections are unequal.

An airfoil of one or more of these clauses, wherein said airfoil is a stationary guide vane.

An airfoil of one or more of these clauses, wherein said airfoil is a rotating blade.

An airfoil for use in an engine, said airfoil comprising: a first side and a second side coupled together at a leading edge and a trailing edge; a plurality of first chord sections having a first thickness and defining at least one first chord length and a plurality of second chord sections having a second thickness and defining at least one second chord length, wherein each first chord section of said plurality of first chord sections is defined between each second chord section of said plurality of second chord sections and wherein the first chord length is longer than the second chord length defining a waveform along a leading edge of the airfoil, said leading edge comprises: a plurality of spaced-apart wave-shaped projections each wave-shaped projection of said plurality of wave-shaped projections defines a wave tip and at least one trough portion defined between at least one pair of adjacent spaced-apart wave-shaped projections, wherein adjacent wave-shaped projections define a tip-to-tip distance therebetween, the tip-to-tip distance is within a range of values representative of a percentage of the at least one first chord length, wherein said wave-shaped projections are at least one of substantially evenly spaced and unevenly spaced, and wherein at least one chord section of said plurality of first chord sections extends outward from one of the first side or the second side of the airfoil at the leading edge, and at least one chord section of said plurality of second chord sections extends outward from one of the first side or the second side of the airfoil at the leading edge, the outwardly extending first and second chord sections and the plurality of spaced-apart wave-shaped projections defining a three-dimensional crenulated airfoil, and wherein the at least one airfoil is configured to facilitate desensitization of an airfoil unsteady pressure response to at least one impinging upstream generated wake or vortex by decorrelating spatially and temporally and reducing in amplitude an unsteady pressure caused by interaction of the airfoil with the upstream generated wake or vortex and minimizing adverse effects of a high flow acceleration around the leading edge.

An airfoil of one or more of these clauses, further comprising a thickness measured between said first and second sides extending from said leading edge to said trailing edge, said airfoil thickness varies in a span-wise direction.

An airfoil of one or more of these clauses, wherein the plurality of spaced-apart wave-shaped projections are formed along one of a portion of the airfoil in a span-wise direction or along substantially an entire length of the airfoil in a span-wise direction.

An airfoil of one or more of these clauses, wherein said airfoil is one of an outlet guide vane, a fan blade, a rotor blade, a stator vane, a ducted fan blade, an unducted fan blade, a strut, a nacelle inlet, a wind turbine blade, a propeller, an impeller, a diffuser vane, or a return channel vane.

A method of fabricating an airfoil, said method comprising: fabricating at least one airfoil including a first side and a second side coupled together at a leading edge and a trailing edge, wherein the airfoil includes a plurality of first chord sections defining at least one first chord length and a plurality of second chord sections defining at least one second chord length, each extending between the trailing and leading edges and defining a waveform along a leading edge of the airfoil, said leading edge defines a length between a root portion of said airfoil and a tip portion of said airfoil, said leading edge comprises: a plurality of spaced-apart wave-shaped projections each wave-shaped projection of said plurality of wave-shaped projections defining a wave tip and at least one trough portion defined between at least one pair of adjacent spaced-apart wave-shaped projections, wherein adjacent wave-shaped projections define a tip-to-tip distance therebetween, the tip-to-tip distance is within a range of values representative of a percentage of the at least one first chord length, wherein said wave-shaped projections are at least one of substantially evenly spaced and unevenly spaced, and wherein at least one chord section of said plurality of first chord sections extends outward from one of the first side or the second side of the airfoil at the leading edge, and at least one chord section of said plurality of second chord sections extends outward from one of the first side or the second side of the airfoil at the leading edge, the outwardly extending first and second chord sections and the plurality of spaced-apart wave-shaped projections defining a three-dimensional crenulated airfoil; and wherein the at least one airfoil is configured to facilitate desensitization of an airfoil unsteady pressure response to at least one impinging upstream generated wake or vortex by decorrelating spatially and temporally and reducing in amplitude an unsteady pressure caused by interaction of the airfoil with the upstream generated wake or vortex.

A method of one or more of these clauses, wherein fabricating the at least one airfoil further comprises fabricating the airfoil such that the airfoil includes a thickness measured between the first and second sides extending between the leading and trailing edges, the airfoil thickness varies in a span-wise direction.

A method of one or more of these clauses, wherein fabricating the at least one airfoil further comprises fabricating the airfoil such that the airfoil is formed with a plurality of first chord sections having a first thickness and a plurality of second chord sections having a second thickness, each first chord section of said plurality of first chord sections are each defined between each second chord section of said plurality of second chord sections.

A method of one or more of these clauses, wherein said airfoil is one of an outlet guide vane, a fan blade, a rotor blade, a stator vane, a ducted fan blade, an unducted fan blade, a strut, a nacelle inlet, a wind turbine blade, a propeller, an impeller, a diffuser vane, a return channel vane, flap leading edges, wing leading edges, or landing gear fairings.

A turbomachine for an aircraft comprising: an annular casing; a fan disposed inside the annular casing and mounted for rotation about an axial centerline, the fan including fan blades that extend radially outwardly toward the annular casing; and an airfoil comprising: a first side and a second side coupled together at a leading edge and a trailing edge, and a plurality of first chord sections defining at least one first chord length and a plurality of second chord sections defining at least one second chord length, the plurality of first chord sections and second chord sections defining a waveform along a leading edge of the airfoil; wherein the fan includes an average fan chord width of the fan blades (“c”), a diameter of the fan (“D”), a fan pressure ratio (“FPR”), and a redline corrected fan tip Mach number (“M_{tip,c}^{(RL)}”) according to a First Performance Factor (“FPF”), wherein

$$FPF = [ \frac{c}{0.15 \cdot D} ] / [ [ \frac{\sqrt{F P R - 1}}{\sqrt{0.4}} ] / {M}_{t ip , c}^{( R L )} ] - 1.23 ,$$

wherein m₁·[M_{tip,c}^{(RL)}−1.1]+9.14>FPF>m₂·[M_{tip,c}^{(RL)}−1.1], and wherein m₁ is equal to 9.43 when M_{tip,c}^{(RL)} is greater than or equal to 1.1 and is equal to 27.02 when M_{tip,c}^{(RL)} is less than 1.1, and wherein m₂ is equal to 0.87 when M_{tip,c}^{(RL)} is greater than or equal to 1.1 and is equal to 3.34 when M_{tip,c}^{(RL)} is less than 1.1.

The turbomachine of one or more of these clauses, wherein FPF is within a range equal to or greater than −0.8 and equal to or less than 8.4.

The turbomachine of claim 1, wherein FPF is within a range equal to or greater than 0 and equal to or less than 6.

The turbomachine of one or more of these clauses, wherein FPF is within a range equal to or greater than 1 and equal to or less than 2.

The turbomachine of one or more of these clauses, wherein M_{tip,c}^{(RL)} is within a range equal to or greater than 0.8 and equal to or less than 1.5.

The turbomachine of one or more of these clauses, wherein M_{tip,c}^{(RL)} is within a range equal to or greater than 0.9 and equal to or less than 1.4.

The turbomachine of one or more of these clauses, wherein ratio c/D is within a range equal to or greater than 0.1 and equal to or less than 0.3.

The turbomachine of one or more of these clauses, wherein FPR is within a range equal to or greater than 1.2 and equal to or less than 1.6.

The turbomachine of one or more of these clauses, wherein FPR is within a range equal to or greater than 1.3 and equal to or less than 1.5.

The turbomachine of one or more of these clauses, wherein FPR is within a range equal to or greater than 1.35 and equal to or less than 1.45.

The turbomachine of one or more of these clauses, wherein the turbomachine has a gear ratio within a range equal to or greater than 3.2 and equal to or less than 5.0.

The turbomachine of one or more of these clauses, wherein the fan blade includes an airfoil portion made from a polymer matrix composite (PMC) material, a metallic leading edge, the ratio c/D is between 0.16 and 0.21, and the fan has between 16 and 25 fan blades.

The turbomachine of one or more of these clauses, wherein: the leading edge comprises a plurality of spaced-apart wave-shaped projections each wave-shaped projection of the plurality of wave-shaped projections defines a wave tip and at least one trough portion defined between at least one pair of adjacent spaced-apart wave-shaped projections, wherein adjacent wave-shaped projections define a tip-to-tip distance therebetween, the tip-to-tip distance is within a range of values representative of a percentage of the at least one first chord length, wherein said wave-shaped projections are at least one of substantially evenly spaced and unevenly spaced; at least one chord section of the plurality of first chord sections extends outward from one of the first side or the second side of the airfoil at the leading edge, and at least one chord section of the plurality of second chord sections extends outward from one of the first side or the second side of the airfoil at the leading edge, the outwardly extending first and second chord sections and the plurality of spaced-apart wave-shaped projections defining a three-dimensional crenulated airfoil; and the airfoil is configured to facilitate desensitization of an airfoil unsteady pressure response to at least one impinging upstream generated wake or vortex by decorrelating spatially and temporally and reducing in amplitude an unsteady pressure caused by interaction of the airfoil with the upstream generated wake or vortex.

The turbomachine of one or more of these clauses, wherein the plurality of spaced-apart wave-shaped projections are formed along only a portion of the airfoil in a span-wise direction.

The turbomachine of one or more of these clauses, wherein the plurality of spaced-apart wave-shaped projections are formed along substantially an entire length of the airfoil in a span-wise direction.

The turbomachine of one or more of these clauses, wherein the plurality of spaced-

apart wave-shaped projections are unequal.

The turbomachine of one or more of these clauses, wherein the plurality of spaced-apart wave-shaped projections are equal.

The turbomachine of one or more of these clauses, wherein a portion of the plurality of spaced-apart wave-shaped projections are equal and a portion of the spaced-apart wave-shaped projections are unequal.

The turbomachine of one or more of these clauses, wherein said airfoil is configured to minimize adverse effects of a high flow acceleration around the leading edge.

The turbomachine of one or more of these clauses, further comprising an airfoil thickness measured between said first and second sides extending from said leading edge to said trailing edge, the airfoil thickness varies in a span-wise direction.

The turbomachine of one or more of these clauses, wherein the plurality of first chord sections has a first thickness and the plurality of second chord sections has a second thickness, each first chord section of the plurality of first chord sections is defined between each second chord section of the plurality of second chord sections.

The turbomachine of one or more of these clauses, wherein the first chord length is longer than the second chord length.

A turbomachine comprising: an annular casing; a fan disposed inside the annular casing and mounted for rotation about an axial centerline, the fan including fan blades that extend radially outwardly toward the annular casing; and an airfoil comprising: a first side and a second side coupled together at a leading edge and a trailing edge, and a plurality of first chord sections defining at least one first chord length and a plurality of second chord sections defining at least one second chord length, the plurality of first chord sections and second chord sections defining a waveform along a leading edge of the airfoil; wherein the fan includes a fan hub-to-tip ratio (“HTR”), a fan blade count (“BC”), a fan pressure ratio (“FPR”), and a redline corrected fan tip Mach number (“M_{tip,c}^{(RL)}”) according to a Second Performance Factor (“SPF”), wherein

$$SPF = \sqrt{\frac{π}{4} ( 1 - H T {R}^{2} ) / ( \frac{B C}{20} )} / ( \frac{\sqrt{F P R - 1}}{\sqrt{0.4}} ) / {M}_{t ip , c}^{( R L )} - 0.97 ,$$

wherein m₃·[M_{tip,c}^{(RL)}−1.1]+2.52>SPF>m₄·[M_{tip,c}^{(RL)}−1.1] wherein m₃ is equal to 3.17, and wherein m₄ is equal to 0.41 when M_{tip,c}^{(RL)} is greater than or equal to 1.1 and is equal to 0.55 when Mine is less than 1.1.

The turbomachine of one or more of these clauses, wherein SPF is within a range equal to or greater than 0.087 and equal to or less than 2.4.

The turbomachine of one or more of these clauses, wherein SPF is within a range equal to or greater than 1 and equal to or less than 2.

The turbomachine of one or more of these clauses, wherein M_{tip,c}^{(RL)} is within a range equal to or greater than 0.8 and equal to or less than 1.5.

The turbomachine of one or more of these clauses, wherein M_{tip,c}^{(RL)} is within a range equal to or greater than 0.9 and equal to or less than 1.4.

The turbomachine of one or more of these clauses, wherein HTR is within a range equal to or greater than 0.2 and equal to or less than 0.4.

The turbomachine of one or more of these clauses, wherein HTR is within a range equal to or greater than 0.25 and equal to or less than 0.35.

The turbomachine of one or more of these clauses, wherein FPR is within a range equal to or greater than 1.2 and equal to or less than 1.6.

The turbomachine of one or more of these clauses, wherein FPR is within a range equal to or greater than 1.3 and equal to or less than 1.5.

The turbomachine of one or more of these clauses, wherein FPR is within a range equal to or greater than 1.35 and equal to or less than 1.45.

The turbomachine of one or more of these clauses, wherein BC is within a range equal to or greater than 3 and equal to or less than 18.

The turbomachine of one or more of these clauses, wherein BC is within a range equal to or greater than 10 and equal to or less than 16.

The turbomachine of one or more of these clauses, wherein the turbomachine has a gear ratio within a range equal to or greater than 3.2 and equal to or less than 5.0.

The turbomachine of one or more of these clauses, wherein the fan blade includes an airfoil portion made from a polymer matrix composite (PMC) material, a metallic leading edge, the ratio c/D is between 0.16 and 0.21, and the fan has between 16 and 25 fan blades.

A turbomachine for an aircraft comprising: an annular casing; a fan disposed inside the annular casing and mounted for rotation about an axial centerline, the fan including fan blades that extend radially outwardly toward the annular casing; and an airfoil comprising: a first side and a second side coupled together at a leading edge and a trailing edge, and a plurality of first chord sections having a first thickness and defining at least one first chord length and a plurality of second chord sections having a second thickness and defining at least one second chord length, wherein each first chord section of said plurality of first chord sections is defined between each second chord section of said plurality of second chord sections and wherein the first chord length is longer than the second chord length defining a waveform along a leading edge of the airfoil; wherein the fan includes an average fan chord width of the fan blades (“c”), a diameter of the fan (“D”), a fan pressure ratio (“FPR”), and a redline corrected fan tip Mach number (“M_{tip,c}^{(RL)}”) according to a First Performance Factor (“FPF”), wherein

$$FPF = [ \frac{c}{0.15 \cdot D} ] / [ [ \frac{\sqrt{F P R - 1}}{\sqrt{0.4}} ] / {M}_{t ip , c}^{( R L )} ] - 1.23 ,$$

wherein m₁·[M_{tip,c}^{(RL)}−1.1]+9.14>FPF>m₂·[M_{tip,c}^{(RL)}−1.1], and wherein m₁ is equal to 9.43 when M_{tip,c}^{(RL)} is greater than or equal to 1.1 and is equal to 27.02 when M_{tip,c}^{(RL)} is less than 1.1, and wherein m₂ is equal to 0.87 when M_{tip,c}^{(RL)} is greater than or equal to 1.1 and is equal to 3.34 when M_{tip,c}^{(RL)} is less than 1.1; wherein the fan includes a fan hub-to-tip ratio (“HTR”), a fan blade count (“BC”), the fan pressure ratio (“FPR”), and the redline corrected fan tip Mach number (“M_{tip,c}^{(RL)}”) according to a Second Performance Factor (“SPF”), wherein

$$SPF = \sqrt{\frac{π}{4} ( 1 - H T {R}^{2} ) / ( \frac{B C}{20} )} / ( \frac{\sqrt{F P R - 1}}{\sqrt{0.4}} ) / {M}_{t ip , c}^{( R L )} - 0.97 ,$$

wherein m₃·[M_{tip,c}^{(RL)}−1.1]+2.52>SPF>m₄·[M_{tip,c}^{(RL)}−1.1] wherein m₃ is equal to 3.17, and wherein m₄ is equal to 0.41 when M_{tip,c}^{(RL)} is greater than or equal to 1.1 and is equal to 0.55 when M_{tip,c}^{(RL)} is less than 1.1.

The turbomachine of one or more of these clauses, wherein FPF is within a range equal to or greater than −0.8 and equal to or less than 8.4.

The turbomachine of one or more of these clauses, wherein FPF is within a range equal to or greater than 0 and equal to or less than 6.

The turbomachine of one or more of these clauses, wherein FPF is within a range equal to or greater than 1 and equal to or less than 2.

The turbomachine of one or more of these clauses, wherein SPF is within a range equal to or greater than 0.087 and equal to or less than 2.4.

The turbomachine of one or more of these clauses, wherein SPF is within a range equal to or greater than 1 and equal to or less than 2.

The turbomachine of one or more of these clauses, wherein M_{tip,c}^{(RL)} is within a range equal to or greater than 0.8 and equal to or less than 1.5.

The turbomachine of one or more of these clauses, wherein M_{tip,c}^{(RL)} is within a range equal to or greater than 0.9 and equal to or less than 1.4.

The turbomachine of one or more of these clauses, wherein ratio c/D is within a range equal to or greater than 0.1 and equal to or less than 0.3.

The turbomachine of one or more of these clauses, wherein HTR is within a range equal to or greater than 0.2 and equal to or less than 0.4.

The turbomachine of one or more of these clauses, wherein HTR is within a range equal to or greater than 0.25 and equal to or less than 0.35.

The turbomachine of one or more of these clauses, wherein FPR is within a range equal to or greater than 1.2 and equal to or less than 1.6.

The turbomachine of one or more of these clauses, wherein FPR is within a range equal to or greater than 1.3 and equal to or less than 1.5.

The turbomachine of one or more of these clauses, wherein FPR is within a range equal to or greater than 1.35 and equal to or less than 1.45.

The turbomachine of one or more of these clauses, wherein BC is within a range equal to or greater than 3 and equal to or less than 18.

The turbomachine of one or more of these clauses, wherein BC is within a range equal to or greater than 10 and equal to or less than 16.

The turbomachine of one or more of these clauses, wherein the turbomachine has a gear ratio within a range equal to or greater than 3.2 and equal to or less than 5.0.

The turbomachine of one or more of these clauses, wherein the fan blade includes an airfoil portion made from a polymer matrix composite (PMC) material, a metallic leading edge, the ratio c/D is between 0.16 and 0.21, and the fan has between 16 and 25 fan blades.

The turbomachine of one or more of these clauses, wherein: the leading edge comprises a plurality of spaced-apart wave-shaped projections each wave-shaped projection of the plurality of wave-shaped projections defines a wave tip and at least one trough portion defined between at least one pair of adjacent spaced-apart wave-shaped projections, wherein adjacent wave-shaped projections define a tip-to-tip distance therebetween, the tip-to-tip distance is within a range of values representative of a percentage of the at least one first chord length, wherein said wave-shaped projections are at least one of substantially evenly spaced and unevenly spaced; at least one chord section of said plurality of first chord sections extends outward from one of the first side or the second side of the airfoil at the leading edge, and at least one chord section of said plurality of second chord sections extends outward from one of the first side or the second side of the airfoil at the leading edge, the outwardly extending first and second chord sections and the plurality of spaced-apart wave-shaped projections defining a three-dimensional crenulated airfoil; and the airfoil is configured to facilitate desensitization of an airfoil unsteady pressure response to at least one impinging upstream generated wake or vortex by decorrelating spatially and temporally and reducing in amplitude an unsteady pressure caused by interaction of the airfoil with the upstream generated wake or vortex and minimizing adverse effects of a high flow acceleration around the leading edge.

The turbomachine of one or more of these clauses, wherein the plurality of spaced-apart wave-shaped projections are formed along one of a portion of the airfoil in a span-wise direction or along substantially an entire length of the airfoil in a span-wise direction.

The turbomachine of one or more of these clauses, further comprising an airfoil thickness measured between said first and second sides extending from said leading edge to said trailing edge, the airfoil thickness varies in a span-wise direction.

What is claimed is:

1. A turbomachine for an aircraft comprising:
an annular casing;
a fan disposed inside the annular casing and mounted for rotation about an axial centerline, the fan including fan blades that extend radially outwardly toward the annular casing; and
an airfoil comprising:
a first side and a second side coupled together at a leading edge and a trailing edge, and
a plurality of first chord sections defining at least one first chord length and a plurality of second chord sections defining at least one second chord length, the plurality of first chord sections and second chord sections defining a waveform along the leading edge of the airfoil;
wherein the fan includes an average fan chord width of the fan blades (“c”), a diameter of the fan (“D”), a fan pressure ratio (“FPR”), and a redline corrected fan tip Mach number (“M_{tip,c}^{(RL)}”) tip,c according to a First Performance Factor (“FPF”),
wherein
$$FPF = [ \frac{c}{0.15 \cdot D} ] / [ [ \frac{\sqrt{F P R - 1}}{\sqrt{0.4}} ] / {M}_{t ip , c}^{( R L )} ] - 1.23 ,$$
wherein m₁·[M_{tip,c}^{(RL)}−1.1]++9.14>FPF>m₂·[M_{tip,c}^{(RL)}−1.1], and
wherein m₁ is equal to 9.43 when M_{tip,c}^{(RL)} is greater than or equal to 1.1 and is equal to 27.02 when M_{tip,c}^{(RL)} is less than 1.1, and
wherein m₂ is equal to 0.87 when M_{tip,c}^{(RL)} is greater than or equal to 1.1 and is equal to 3.34 when M_{tip,c}^{(RL)} is less than 1.1.

2. The turbomachine of claim 1, wherein:
FPF is within a range equal to or greater than −0.8 and equal to or less than 8.4;
M_{tip,c}^{(RL)} is within a range equal to or greater than 0.8 and equal to or less than 1.5;
ratio c/D is within a range equal to or greater than 0.1 and equal to or less than 0.3; and
FPR is within a range equal to or greater than 1.2 and equal to or less than 1.6.

3. The turbomachine of claim 1, wherein the turbomachine has a gear ratio within a range equal to or greater than 3.2 and equal to or less than 5.0.

4. The turbomachine of claim 1, wherein the fan blade includes an airfoil portion made from a polymer matrix composite (PMC) material, a metallic leading edge, the ratio c/D is between 0.16 and 0.21, and the fan has between 16 and 25 fan blades.

5. The turbomachine of claim 1, wherein:
the leading edge comprises a plurality of spaced-apart wave-shaped projections, wherein each wave-shaped projection of the plurality of wave-shaped projections defines a wave tip and at least one trough portion defined between at least one pair of adjacent spaced-apart wave-shaped projections, wherein adjacent wave-shaped projections define a tip-to-tip distance therebetween, the tip-to-tip distance is within a range of values representative of a percentage of the at least one first chord length, wherein said wave-shaped projections are at least one of substantially evenly spaced and unevenly spaced;
at least one chord section of the plurality of first chord sections extends outward from one of the first side or the second side of the airfoil at the leading edge, and at least one chord section of the plurality of second chord sections extends outward from one of the first side or the second side of the airfoil at the leading edge, the outwardly extending first and second chord sections and the plurality of spaced-apart wave-shaped projections defining a three-dimensional crenulated airfoil; and
the airfoil is configured to facilitate desensitization of an airfoil unsteady pressure response to at least one impinging upstream generated wake or vortex by decorrelating spatially and temporally and reducing in amplitude an unsteady pressure caused by interaction of the airfoil with the upstream generated wake or vortex.

6. The turbomachine of claim 5, wherein the plurality of spaced-apart wave-shaped projections are formed along only a portion of the airfoil in a span-wise direction.

7. The turbomachine of claim 5, wherein the plurality of spaced-apart wave-shaped projections are formed along substantially an entire length of the airfoil in a span-wise direction.

8. The turbomachine of claim 5, wherein the plurality of spaced-apart wave-shaped projections are unequal.

9. The turbomachine of claim 5, wherein the plurality of spaced-apart wave-shaped projections are equal.

10. The turbomachine of claim 5, wherein a portion of the plurality of spaced-apart wave-shaped projections are equal and a portion of the spaced-apart wave-shaped projections are unequal.

11. The turbomachine of claim 1, further comprising an airfoil thickness measured between said first and second sides extending from said leading edge to said trailing edge, the airfoil thickness varies in a span-wise direction.

12. The turbomachine of claim 1, wherein the plurality of first chord sections has a first thickness and the plurality of second chord sections has a second thickness, each first chord section of the plurality of first chord sections is defined between each second chord section of the plurality of second chord sections.

13. The turbomachine of claim 1, wherein the first chord length is longer than the second chord length.

14. A turbomachine comprising:
an annular casing;
a fan disposed inside the annular casing and mounted for rotation about an axial centerline, the fan including fan blades that extend radially outwardly toward the annular casing; and
an airfoil comprising:
a first side and a second side coupled together at a leading edge and a trailing edge, and
a plurality of first chord sections defining at least one first chord length and a plurality of second chord sections defining at least one second chord length, the plurality of first chord sections and second chord sections defining a waveform along a leading edge of the airfoil;
wherein the fan includes a fan hub-to-tip ratio (“HTR”), a fan blade count (“BC”), a fan pressure ratio (“FPR”), and a redline corrected fan tip Mach number (“M_{tip,c}^{(RL)}”)) according to a Second Performance Factor (“SPF”),
wherein
$$SPF = \sqrt{\frac{π}{4} ( 1 - H T {R}^{2} ) / ( \frac{B C}{20} )} / ( \frac{\sqrt{F P R - 1}}{\sqrt{0.4}} ) / {M}_{t ip , c}^{( R L )} - 0.97 ,$$
wherein m₃·[M_{tip,c}^{(RL)}−1.1]+2.52>SPF>m₄·[M_{tip,c}^{(RL)}−1.1]
wherein m₃ is equal to 3.17, and
wherein m₄ is equal to 0.41 when M_{tip,c}^{(RL)} is greater than or equal to 1.1 and is equal to 0.55 when M_{tip,c}^{(RL)} is less than 1.1.

15. The turbomachine of claim 14, wherein:
SPF is within a range equal to or greater than 0.087 and equal to or less than 2.4;
M_{tip,c}^{(RL)} is within a range equal to or greater than 0.8 and equal to or less than 1.5;
HTR is within a range equal to or greater than 0.2 and equal to or less than 0.4;
FPR is within a range equal to or greater than 1.2 and equal to or less than 1.6; and
BC is within a range equal to or greater than 3 and equal to or less than 18.

16. A turbomachine for an aircraft comprising:
an annular casing;
a fan disposed inside the annular casing and mounted for rotation about an axial centerline, the fan including fan blades that extend radially outwardly toward the annular casing; and
an airfoil comprising:
a first side and a second side coupled together at a leading edge and a trailing edge, and
a plurality of first chord sections having a first thickness and defining at least one first chord length and a plurality of second chord sections having a second thickness and defining at least one second chord length, wherein each first chord section of said plurality of first chord sections is defined between each second chord section of said plurality of second chord sections and wherein the first chord length is longer than the second chord length defining a waveform along a leading edge of the airfoil;
wherein the fan includes an average fan chord width of the fan blades (“c”), a diameter of the fan (“D”), a fan pressure ratio (“FPR”), and a redline corrected fan tip Mach number (“M_{tip,c}^{(RL)}”) according to a First Performance Factor (“FPF”),
wherein
$$FPF = [ \frac{c}{0.15 \cdot D} ] / [ [ \frac{\sqrt{F P R - 1}}{\sqrt{0.4}} ] / {M}_{t ip , c}^{( R L )} ] - 1.23 ,$$
wherein m₁·[M_{tip,c}^{(RL)}−1.1]+9.14>FPF>m₂·[M_{tip,c}^{(RL)}−1.1], and
wherein m₁ is equal to 9.43 when M_{tip,c}^{(RL)} is greater than or equal to 1.1 and is equal to 27.02 when M_{tip,c}^{(RL)} is less than 1.1, and
wherein m₂ is equal to 0.87 when M_{tip,c}^{(RL)} is greater than or equal to 1.1 and is equal to 3.34 when M_{tip,c}^{(RL)} is less than 1.1;
wherein the fan includes a fan hub-to-tip ratio (“HTR”), a fan blade count (“BC”), the fan pressure ratio (“FPR”), and the redline corrected fan tip Mach number (“M_{tip,c}^{(RL)}”) according to a Second Performance Factor (“SPF”),
wherein
$$SPF = \sqrt{\frac{π}{4} ( 1 - H T {R}^{2} ) / ( \frac{B C}{20} )} / ( \frac{\sqrt{F P R - 1}}{\sqrt{0.4}} ) / {M}_{t ip , c}^{( R L )} - 0.97 ,$$
wherein m₃·[M_{tip,c}^{(RL)}−1.1]+2.52>SPF>m₄·[M_{tip,c}^{(RL)}−1.1]
wherein m₃ is equal to 3.17, and
wherein m₄ is equal to 0.41 when M_{tip,c}^{(RL)} is greater than or equal to 1.1 and is equal to 0.55 when M_{tip,c}^{(RL)} is less than 1.1.

17. The turbomachine of claim 16, wherein:
FPF is within a range equal to or greater than −0.8 and equal to or less than 8.4;
SPF is within a range equal to or greater than 0.087 and equal to or less than 2.4;
M_{tip,c}^{(RL)} is within a range equal to or greater than 0.8 and equal to or less than 1.5;
ratio c/D is within a range equal to or greater than 0.1 and equal to or less than 0.3;
HTR is within a range equal to or greater than 0.2 and equal to or less than 0.4;
FPR is within a range equal to or greater than 1.2 and equal to or less than 1.6; and
BC is within a range equal to or greater than 3 and equal to or less than 18.

18. The turbomachine of claim 16, wherein:
the leading edge comprises a plurality of spaced-apart wave-shaped projections, wherein each wave-shaped projection of the plurality of wave-shaped projections defines a wave tip and at least one trough portion defined between at least one pair of adjacent spaced-apart wave-shaped projections, wherein adjacent wave-shaped projections define a tip-to-tip distance therebetween, the tip-to-tip distance is within a range of values representative of a percentage of the at least one first chord length, wherein said wave-shaped projections are at least one of substantially evenly spaced and unevenly spaced;
at least one chord section of said plurality of first chord sections extends outward from one of the first side or the second side of the airfoil at the leading edge, and at least one chord section of said plurality of second chord sections extends outward from one of the first side or the second side of the airfoil at the leading edge, the outwardly extending first and second chord sections and the plurality of spaced-apart wave-shaped projections defining a three-dimensional crenulated airfoil; and
the airfoil is configured to facilitate desensitization of an airfoil unsteady pressure response to at least one impinging upstream generated wake or vortex by decorrelating spatially and temporally and reducing in amplitude an unsteady pressure caused by interaction of the airfoil with the upstream generated wake or vortex and minimizing adverse effects of a high flow acceleration around the leading edge.

19. The turbomachine of claim 18, wherein the plurality of spaced-apart wave-shaped projections are formed along one of a portion of the airfoil in a span-wise direction or along substantially an entire length of the airfoil in a span-wise direction.

20. The turbomachine of claim 16, further comprising an airfoil thickness measured between said first and second sides extending from said leading edge to said trailing edge, the airfoil thickness varies in a span-wise direction.
